(19) United States
(12) Patent Application Publication
(10) Pub. No.: US 2015/0080518 A1
(43) Pub. Date: Mar. 19, 2015

(54) FIBER REINFORCED THERMOPLASTIC RESIN COMPOSITIONS

(71) Applicant: SABIC Innovative Plastics IP B.V.

(72) Inventor: Mohammad Moniruzzaman, Exton, PA (US)

(73) Assignees: SABIC Innovative Plastics IP B.V.; Plasticslaan 1, Bergen op Zoom (NL)

(21) Appl. No.: 14/027,802

(22) Filed: Sep. 16, 2013

(51) Int. Cl. C08L 69/00; C08L 67/00

(52) U.S. Cl. CPC C08L 69/00; C08L 67/00
USPC 524/504

(57) ABSTRACT

Disclosed herein are fiber reinforced thermoplastic composition comprising: a thermoplastic polymer component comprising a polycarbonate, or polyalkylene terephthalate, or a combination thereof; a reinforcement fiber component; and a maleic anhydride additive component. The resulting fiber reinforced thermoplastic compositions exhibit improved mechanical performance at room temperature and high temperatures.

### FIELD OF THE INVENTION

The present invention relates generally to thermoplastic compositions having improved properties. The compositions generally comprise a thermoplastic polymer component; a reinforcement fiber component; and a maleic anhydride additive component.

### BACKGROUND OF THE INVENTION

Carbon fiber reinforced polycarbonate (PC), polyalkylene terephthalate (PAT) and polycarbonate/polyalkylene terephthalate (PC/PAT) blends exhibit good stiffness, strength and impact resistance at room temperature. Due to their high stiffness and strength, these compounds may be suitable for certain structural applications in the automotive or

However, widespread application of these compounds may be limited due to the moderate or poor performance of these compounds at high temperatures. Accordingly, there remains a need for fiber reinforced polycarbonate (PC), polyalkylene terephthalate (PAT) and polycarbonate/polyalkylene terephthalate (PC/PAT) blends that exhibit room temperature as well as high temperature mechanical performance. This need and other needs are satisfied by the various aspects of the present disclosure.

### SUMMARY OF THE INVENTION

In accordance with the purposes of the invention, as embodied and broadly described herein, the invention provides a fiber reinforced thermoplastic composition comprising: a) a thermoplastic polymer component comprising a polycarbonate, or polyalkylene terephthalate, or a combination thereof; b) a reinforcement fiber component; and c) a maleic anhydride additive component.

In a still further exemplary aspect, the invention relates to a fiber reinforced thermoplastic composition comprising: a) from about 30 wt. % to less than 100 wt. % of a thermoplastic polymer component comprising a polycarbonate, or polyalkylene terephthalate, or a combination thereof; b) from greater than 0 wt. % to about 70 wt. % of a reinforcement filler component; and c) from greater than 0 wt. % to about 10 wt. % of a maleic anhydride additive component.

In a still further exemplary aspect, the invention relates to a fiber reinforced thermoplastic composition, comprising: a) from about 60 wt. % to about 90 wt. % of a thermoplastic polymer component comprising a polycarbonate (PC), polybutylene terephthalate (PBT), or polycarbonate-polybutylene terephthalate (PC/PBT) blend; b) from greater than 10 wt. % to about 30 wt. % of a reinforcement filler component; and c) from greater than 0 wt. % to about 6 wt. % of a maleic anhydride additive component comprising maleic anhydride grafted polypropylene.

In a still further exemplary aspect, the invention relates to a method for forming a thermoplastic blend comprising: combining: i) a thermoplastic polymer component comprising a polycarbonate, or polyalkylene terephthalate, or a combination thereof; ii) a reinforcement fiber component; and iii) a maleic anhydride additive component.

In a still further exemplary aspect, the invention relates to a method for forming a thermoplastic blend comprising: combining: i) a thermoplastic polymer component comprising a polycarbonate, or polyalkylene terephthalate, or a combination thereof; ii) a reinforcement fiber component; and iii) a maleic anhydride additive component; and b) extruding the thermoplastic blend. In further aspects, the step of combining comprises extrusion blending. In still further aspects, the method further comprises step of molding the thermoplastic polymer blend composition into a molded article.

In further aspects, the invention also relates to articles comprising the disclosed compositions and articles made using the disclosed methods.

Additional aspects of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE FIGURES

The accompanying figures, which are incorporated in and constitute a part of this specification, illustrate several aspects and together with the description serve to explain the principles of the invention.

FIG. 1 is a graph showing the tensile modulus performance improvement of the inventive compounds over the comparative compounds at various temperatures in accordance with the present invention.

FIG. 2 is a graph showing the tensile strength performance improvement of the inventive compounds over the comparative compounds at various temperatures in accordance with the present invention.

### DETAILED DESCRIPTION OF THE INVENTION

The present invention can be understood more readily by reference to the following detailed description of the invention and the examples included therein.

Before the present compounds, compositions, articles, systems, devices, and/or methods are disclosed and described, it is to be understood that they are not limited to specific synthetic methods unless otherwise specified, or to particular reagents unless otherwise specified, as such can, of course, vary. It is also to be understood that the terminology used herein is for the purpose of describing particular aspects only and is not intended to be limiting. Although any methods and materials similar or equivalent to those described herein can be used in the practice or testing of the present invention, example methods and materials are now described.

Moreover, it is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of aspects described in the specification.

All publications mentioned herein are incorporated herein by reference to disclose and describe the methods and/or materials in connection with which the publications are cited.

### A. DEFINITIONS

It is also to be understood that the terminology used herein is for the purpose of describing particular aspects only and is not intended to be limiting. As used in the specification and in the claims, the term “comprising” can include the aspects “consisting of” and “consisting essentially of.” Unless defined otherwise, all technical and scientific terms used herein have the same meaning as commonly understood by one of ordinary skill in the art to which this invention belongs. In this specification and in the claims which follow, reference will be made to a number of terms which shall be defined herein.

As used in the specification and the appended claims, the singular forms “a,” “an” and “the” include plural referents unless the context clearly dictates otherwise. Thus, for example, reference to “a polymer” includes mixtures of two or more polymers.

As used herein, the term “combination” is inclusive of blends, mixtures, alloys, reaction products, and the like.

Ranges can be expressed herein as from one particular value, and/or to another particular value. When such a range is expressed, another aspect includes from the one particular value and/or to the other particular value. Similarly, when values are expressed as approximations, by use of the antecedent ‘about,’ it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

The terms “first,” “second,” “first part,” “second part,” and the like, where used herein, do not denote any order, quantity, or importance, and are used to distinguish one element from another, unless specifically stated otherwise.

As used herein, the terms “optional” or “optionally” means that the subsequently described event or circumstance can or cannot occur, and that the description includes instances where said event or circumstance occurs and instances where it does not. For example, the phrase “optionally substituted alkyl” means that the alkyl group can or cannot be substituted and that the description includes both substituted and unsubstituted alkyl groups.

Moreover, it is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of aspects described in the specification.

Disclosed are the components to be used to prepare the compositions of the invention as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds cannot be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the invention. Thus, if there are a variety of additional steps that can be performed it is understood that each of these additional steps can be performed with any specific aspect or combination of aspects of the methods of the invention.

References in the specification and concluding claims to parts by weight, of a particular element or component in a composition or article, denotes the weight relationship between the element or component and any other elements or components in the composition or article for which a part by weight is expressed. Thus, in a compound containing 2 parts by weight of component X and 5 parts by weight component Y, X and Y are present at a weight ratio of 2:5, and are present in such ratio regardless of whether additional components are contained in the compound.

A weight percent (“wt %”) of a component, unless specifically stated to the contrary, is based on the total weight of the formulation or composition in which the component is included. For example if a particular element or component in a composition or article is said to have 8% by weight, it is understood that this percentage is relative to a total compositional percentage of 100% by weight.

As used herein, the term or phrase “effective,” “effective amount,” or “conditions effective to” refers to such amount or condition that is capable of performing the function or property for which an effective amount is expressed. As will be pointed out below, the exact amount or particular condition required will vary from one aspect to another, depending on recognized variables such as the materials employed and the processing conditions observed. Thus, it is not always possible to specify an exact “effective amount” or “condition effective to.” However, it should be understood that an appropriate effective amount will be readily determined by one of ordinary skill in the art using only routine experimentation.

As used herein, the term “substantially identical reference composition” refers to a composition that is substantially identical to the inventive composition by consisting essentially of substantially the same proportions and components but in the absence of a stated component. For example and without limitation, in some aspects of the invention, for purposes of comparison to a corresponding reference composition, as used herein, a corresponding reference composition consists essentially of the same component materials in the same component amounts as the inventive composition but for the absence of the maleic anhydride additive component. To that end, in an exemplary corresponding reference composition the weight percentage amount of the thermoplastic polymer component is increased an equivalent amount to compensate for the absence of the maleic anhydride additive component.

Compounds are described using standard nomenclature. For example, any position not substituted by any indicated group is understood to have its valence filled by a bond as indicated, or a hydrogen atom. A dash (“—”) that is not between two letters or symbols is used to indicate a point of attachment for a substituent. For example, —CHO is attached through carbon of the carbonyl group. Unless defined otherwise, technical and scientific terms used herein have the same meaning as is commonly understood by one of skill in the art to which this invention belongs.

The term “alkyl group” as used herein is a branched or unbranched saturated hydrocarbon group of 1 to 24 carbon atoms, such as methyl, ethyl, n propyl, isopropyl, n butyl, isobutyl, t butyl, pentyl, hexyl, heptyl, octyl, decyl, tetradecyl, hexadecyl, eicosyl, tetracosyl and the like. A “lower alkyl” group is an alkyl group containing from one to six carbon atoms.

The term “aryl group” as used herein is any carbon-based aromatic group including, but not limited to, benzene, naphthalene, etc. The term “aromatic” also includes “heteroaryl group,” which is defined as an aromatic group that has at least one heteroatom incorporated within the ring of the aromatic group. Examples of heteroatoms include, but are not limited to, nitrogen, oxygen, sulfur, and phosphorus. The aryl group can be substituted or unsubstituted. The aryl group can be substituted with one or more groups including, but not limited to, alkyl, alkynyl, alkenyl, aryl, halide, nitro, amino, ester, ketone, aldehyde, hydroxy, carboxylic acid, or alkoxy.

The term “aralkyl” as used herein is an aryl group having an alkyl, alkynyl, or alkenyl group as defined above attached to the aromatic group. An example of an aralkyl group is a benzyl group.

The term “ester” as used herein is represented by the formula —C(O)OA, where A can be an alkyl, halogenated alkyl, alkenyl, alkynyl, aryl, heteroaryl, cycloalkyl, cycloalkenyl, heterocycloalkyl, or heterocycloalkenyl group described above.

The term “carbonate group” as used herein is represented by the formula —OC(O)OR, where R can be hydrogen, an alkyl, alkenyl, alkynyl, aryl, aralkyl, cycloalkyl, halogenated alkyl, or heterocycloalkyl group described above.

The term “carboxylic acid” as used herein is represented by the formula —C(O)OH.

The term “aldehyde” as used herein is represented by the formula —C(O)H.

The term “keto group” as used herein is represented by the formula —C(O)R, where R is an alkyl, alkenyl, alkynyl, aryl, aralkyl, cycloalkyl, halogenated alkyl, or heterocycloalkyl group described above.

The term “carbonyl group” as used herein is represented by the formula C═O.

The term “ether” as used herein is represented by the formula AOA¹, where A and A¹ can be, independently, an alkyl, halogenated alkyl, alkenyl, alkynyl, aryl, heteroaryl, cycloalkyl, cycloalkenyl, heterocycloalkyl, or heterocycloalkenyl group described above.

The term “organic residue” or “residue” defines a carbon containing residue, i.e., a residue comprising at least one carbon atom, and includes but is not limited to the carbon-containing groups, residues, or radicals defined hereinabove. Organic residues can contain various heteroatoms, or be bonded to another molecule through a heteroatom, including oxygen, nitrogen, sulfur, phosphorus, or the like. Examples of organic residues include but are not limited alkyl or substituted alkyls, alkoxy or substituted alkoxy, mono or di-substituted amino, amide groups, etc. Organic residues can preferably comprise 1 to 18 carbon atoms, 1 to 15, carbon atoms, 1 to 12 carbon atoms, 1 to 8 carbon atoms, 1 to 6 carbon atoms, or 1 to 4 carbon atoms. In a further aspect, an organic residue can comprise 2 to 18 carbon atoms, 2 to 15, carbon atoms, 2 to 12 carbon atoms, 2 to 8 carbon atoms, 2 to 4 carbon atoms, or 2 to 4 carbon atoms.

A very close synonym of the term “residue” is the term “radical,” which as used in the specification and concluding claims, refers to a fragment, group, or substructure of a molecule described herein, regardless of how the molecule is prepared. For example, a 2,4-dihydroxyphenyl radical in a particular compound has the structure:

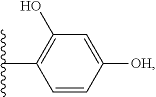 [SMILES: *c1ccc(O)cc1O]

regardless of whether 2,4-dihydroxyphenyl is used to prepare the compound. In some aspects the radical (for example an alkyl) can be further modified (i.e., substituted alkyl) by having bonded thereto one or more “substituent radicals.” The number of atoms in a given radical is not critical to the present invention unless it is indicated to the contrary elsewhere herein.

“Organic radicals,” as the term is defined and used herein, contain one or more carbon atoms. An organic radical can have, for example, 1-26 carbon atoms, 1-18 carbon atoms, 1-12 carbon atoms, 1-8 carbon atoms, 1-6 carbon atoms, or 1-4 carbon atoms. In a further aspect, an organic radical can have 2-26 carbon atoms, 2-18 carbon atoms, 2-12 carbon atoms, 2-8 carbon atoms, 2-6 carbon atoms, or 2-4 carbon atoms. Organic radicals often have hydrogen bound to at least some of the carbon atoms of the organic radical. One example, of an organic radical that comprises no inorganic atoms is a 5,6,7,8-tetrahydro-2-naphthyl radical. In some aspects, an organic radical can contain 1-10 inorganic heteroatoms bound thereto or therein, including halogens, oxygen, sulfur, nitrogen, phosphorus, and the like. Examples of organic radicals include but are not limited to an alkyl, substituted alkyl, cycloalkyl, substituted cycloalkyl, mono-substituted amino, di-substituted amino, acyloxy, cyano, carboxy, carboalkoxy, alkylcarboxamide, substituted alkylcarboxamide, dialkylcarboxamide, substituted dialkylcarboxamide, alkylsulfonyl, alkylsulfinyl, thioalkyl, thiohaloalkyl, alkoxy, substituted alkoxy, haloalkyl, haloalkoxy, aryl, substituted aryl, heteroaryl, heterocyclic, or substituted heterocyclic radicals, wherein the terms are defined elsewhere herein. A few non-limiting examples of organic radicals that include heteroatoms include alkoxy radicals, trifluoromethoxy radicals, acetoxy radicals, dimethylamino radicals and the like.

As used herein, the terms “number average molecular weight” or “Mₙ” can be used interchangeably, and refer to the statistical average molecular weight of all the polymer chains in the sample and is defined by the formula:

$${M}_{n} = \frac{\sum {N}_{i} {M}_{i}}{\sum {N}_{i}} ,$$

where Mᵢ is the molecular weight of a chain and Nᵢ is the number of chains of that molecular weight. Mₙ can be determined for polymers, e.g. polycarbonate polymers, by methods well known to a person having ordinary skill in the art using molecular weight standards, e.g. polycarbonate standards or polystyrene standards, preferably certified or traceable molecular weight standards.

As used herein, the terms “weight average molecular weight” or “Mw” can be used interchangeably, and are defined by the formula:

$${M}_{w} = \frac{\sum {N}_{i} {M}_{i}^{2}}{\sum {N}_{i} {M}_{i}} ,$$

where Mᵢ is the molecular weight of a chain and Nᵢ is the number of chains of that molecular weight. Compared to Mₙ, M_{w} takes into account the molecular weight of a given chain in determining contributions to the molecular weight average. Thus, the greater the molecular weight of a given chain, the more the chain contributes to the M_{w}. M_{w} can be determined for polymers, e.g. polycarbonate polymers, by methods well known to a person having ordinary skill in the art using molecular weight standards, e.g. polycarbonate standards or polystyrene standards, preferably certified or traceable molecular weight standards.

Each of the materials disclosed herein are either commercially available and/or the methods for the production thereof are known to those of skill in the art.

It is understood that the compositions disclosed herein have certain functions. Disclosed herein are certain structural requirements for performing the disclosed functions, and it is understood that there are a variety of structures that can perform the same function that are related to the disclosed structures, and that these structures will typically achieve the same result.

### B. FIBER REINFORCED THERMOPLASTIC RESIN COMPOSITION

As used herein, fiber reinforced thermoplastic resin composition is synonymous with fiber reinforced thermoplastic resin composition, thermoplastic composition, resin composition, fiber reinforced thermoplastic resin composite, thermoplastic composite, resin composite, or composite.

As briefly described above, the present disclosure relates, in one aspect, to a fiber reinforced thermoplastic composition comprising: a fiber reinforced thermoplastic composition comprising: a) a thermoplastic polymer component comprising a polycarbonate, or polyalkylene terephthalate, or a combination thereof; b) a reinforcement fiber component; and c) a maleic anhydride additive component.

In further aspects, described herein is a fiber reinforced thermoplastic composition comprising: a) from about 30 wt. % to less than 100 wt. % of a thermoplastic polymer component comprising a polycarbonate, or polyalkylene terephthalate, or a combination thereof; b) from greater than 0 wt. % to about 70 wt. % of a reinforcement filler component; and c) from greater than 0 wt. % to about 10 wt. % of a maleic anhydride additive component.

In further aspects, described herein is a fiber reinforced thermoplastic composition, comprising: a) from about 60 wt. % to about 90 wt. % of a thermoplastic polymer component comprising a polycarbonate (PC), polybutylene terephthalate (PBT), or polycarbonate-polybutylene terephthalate (PC/PBT) blend; b) from greater than 10 wt. % to about 30 wt. % of a reinforcement filler component; and c) from greater than 0 wt. % to about 6 wt. % of a maleic anhydride additive component comprising maleic anhydride grafted polypropylene.

1. Polycarbonate Polymer

In one aspect, the disclosed fiber reinforced thermoplastic compositions comprise a polycarbonate polymer composition wherein the polycarbonate polymer comprising bisphenol A, a polycarbonate copolymer, polyester carbonate polymer, or polycarbonate-polysiloxane copolymer, or combinations thereof.

In one aspect, a polycarbonate can comprise any polycarbonate material or mixture of materials, for example, as recited in U.S. Pat. No. 7,786,246, which is hereby incorporated in its entirety for the specific purpose of disclosing various polycarbonate compositions and methods. The term polycarbonate can be further defined as compositions have repeating structural units of the formula (1):

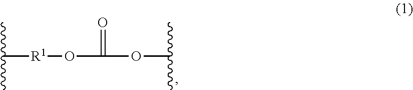

in which at least 60 percent of the total number of R¹ groups are aromatic organic radicals and the balance thereof are aliphatic, alicyclic, or aromatic radicals. In a further aspect, each R¹ is an aromatic organic radical and, more preferably, a radical of the formula (2):

-A¹-Y¹-A²- (2),

wherein each of A¹ and A² is a monocyclic divalent aryl radical and Y¹ is a bridging radical having one or two atoms that separate A¹ from A². In various aspects, one atom separates A¹ from A². For example, radicals of this type include, but are not limited to, radicals such as —O—, —S—, —S(O)—, —S(O₂)—, —C(O)—, methylene, cyclohexyl-methylene, 2-[2.2.1]-bicycloheptylidene, ethylidene, isopropylidene, neopentylidene, cyclohexylidene, cyclopentadecylidene, cyclododecylidene, and adamantylidene. The bridging radical Y¹ is preferably a hydrocarbon group or a saturated hydrocarbon group such as methylene, cyclohexylidene, or isopropylidene.

In a further aspect, polycarbonates can be produced by the interfacial reaction of dihydroxy compounds having the formula HO—R¹—OH, which includes dihydroxy compounds of formula (3):

HO-A¹-Y¹-A²-OH (3),

wherein Y¹, A¹ and A² are as described above. Also included are bisphenol compounds of general formula (4):

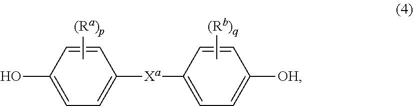

wherein R^{a} and R^{b} each represent a halogen atom or a monovalent hydrocarbon group and can be the same or different; p and q are each independently integers from 0 to 4; and X^{a} represents one of the groups of formula (5):

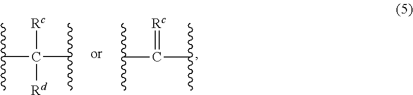

wherein R^{c} and R^{d} each independently represent a hydrogen atom or a monovalent linear or cyclic hydrocarbon group and R^{e} is a divalent hydrocarbon group.

In various aspects, a heteroatom-containing cyclic alkylidene group comprises at least one heteroatom with a valency of 2 or greater, and at least two carbon atoms. Heteroatoms for use in the heteroatom-containing cyclic alkylidene group include —O—, —S—, and —N(Z)-, where Z is a substituent group selected from hydrogen, hydroxy, C₁₋₁₂ alkyl, C₁₋₁₂ alkoxy, or C₁₋₁₂ acyl. Where present, the cyclic alkylidene group or heteroatom-containing cyclic alkylidene group can have 3 to 20 atoms, and can be a single saturated or unsaturated ring, or fused polycyclic ring system wherein the fused rings are saturated, unsaturated, or aromatic.

In various aspects, examples of suitable dihydroxy compounds include the dihydroxy-substituted hydrocarbons disclosed by name or formula (generic or specific) in U.S. Pat. No. 4,217,438. A nonexclusive list of specific examples of suitable dihydroxy compounds includes the following: resorcinol, 4-bromoresorcinol, hydroquinone, 4,4′-dihydroxybiphenyl, 1,6-dihydroxynaphthalene, 2,6-dihydroxynaphthalene, bis(4-hydroxyphenyl)methane, bis(4-hydroxyphenyl)diphenylmethane, bis(4-hydroxyphenyl)-1-naphthylmethane, 1,2-bis(4-hydroxyphenyl)ethane, 1,1-bis(4-hydroxyphenyl)-1-phenylethane, 2-(4-hydroxyphenyl)-2-(3-hydroxyphenyl)propane, bis(4-hydroxyphenyl)phenylmethane, 2,2-bis(4-hydroxy-3-bromophenyl)propane, 1,1-bis (hydroxyphenyl)cyclopentane, 1,1-bis(4-hydroxyphenyl)cyclohexane, 1,1-bis(4-hydroxyphenyl)isobutene, 1,1-bis(4-hydroxyphenyl)cyclododecane, trans-2,3-bis(4-hydroxyphenyl)-2-butene, 2,2-bis(4-hydroxyphenyl)adamantine, (alpha,alpha′-bis(4-hydroxyphenyl)toluene, bis(4-hydroxyphenyl)acetonitrile, 2,2-bis(3-methyl-4-hydroxyphenyl)propane, 2,2-bis(3-ethyl-4-hydroxyphenyl)propane, 2,2-bis(3-n-propyl-4-hydroxyphenyl)propane, 2,2-bis(3-isopropyl-4-hydroxyphenyl)propane, 2,2-bis(3-sec-butyl-4-hydroxyphenyl)propane, 2,2-bis(3-t-butyl-4-hydroxyphenyl)propane, 2,2-bis(3-cyclohexyl-4-hydroxyphenyl)propane, 2,2-bis(3-allyl-4-hydroxyphenyl)propane, 2,2-bis(3-methoxy-4-hydroxyphenyl)propane, 2,2-bis(4-hydroxyphenyl)hexafluoropropane, 1,1-dichloro-2,2-bis(4-hydroxyphenyl)ethylene, 1,1-dibromo-2,2-bis(4-hydroxyphenyl)ethylene, 1,1-dichloro-2,2-bis(5-phenoxy-4-hydroxyphenyl)ethylene, 4,4′-dihydroxybenzophenone, 3,3-bis(4-hydroxyphenyl)-2-butanone, 1,6-bis(4-hydroxyphenyl)-1,6-hexanedione, ethylene glycol bis(4-hydroxyphenyl)ether, bis(4-hydroxyphenyl)ether, bis(4-hydroxyphenyl)sulfide, bis(4-hydroxyphenyl)sulfoxide, bis(4-hydroxyphenyl)sulfone, 9,9-bis(4-hydroxyphenyl)fluorine, 2,7-dihydroxypyrene, 6,6′-dihydroxy-3,3,3′,3′-tetramethylspiro(bis)indane (“spirobiindane bisphenol”), 3,3-bis(4-hydroxyphenyl)phthalide, 2,6-dihydroxydibenzo-p-dioxin, 2,6-dihydroxythianthrene, 2,7-dihydroxyphenoxathin, 2,7-dihydroxy-9,10-dimethylphenazine, 3,6-dihydroxydibenzofuran, 3,6-dihydroxydibenzothiophene, 2,7-dihydroxycarbazole, 3,3-bis(4-hydroxyphenyl)phthalimidine, 2-phenyl-3,3-bis-(4-hydroxyphenyl)phthalimidine (PPPBP), and the like, as well as mixtures including at least one of the foregoing dihydroxy compounds.

In a further aspect, examples of the types of bisphenol compounds that can be represented by formula (3) includes 1,1-bis(4-hydroxyphenyl)methane, 1,1-bis(4-hydroxyphenyl)ethane, 2,2-bis(4-hydroxyphenyl)propane (hereinafter “bisphenol A” or “BPA”), 2,2-bis(4-hydroxyphenyl)butane, 2,2-bis(4-hydroxyphenyl)octane, 1,1-bis(4-hydroxyphenyl)propane, 1,1-bis(4-hydroxyphenyl)n-butane, 2,2-bis(4-hydroxy-1-methylphenyl)propane, and 1,1-bis(4-hydroxy-t-butylphenyl)propane. Combinations including at least one of the foregoing dihydroxy compounds can also be used.

In various further aspects, bisphenols containing substituted or unsubstituted cyclohexane units can be used, for example bisphenols of formula (6):

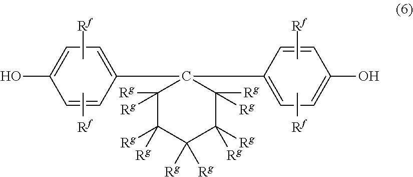

wherein each R^{f} is independently hydrogen, C₁₋₁₂ alkyl, or halogen; and each R^{g} is independently hydrogen or C₁₋₁₂ alkyl. The substituents can be aliphatic or aromatic, straight chain, cyclic, bicyclic, branched, saturated, or unsaturated. Such cyclohexane-containing bisphenols, for example the reaction product of two moles of a phenol with one mole of a hydrogenated isophorone, are useful for making polycarbonate polymers with high glass transition temperatures and high heat distortion temperatures. Cyclohexyl bisphenol containing polycarbonates, or a combination comprising at least one of the foregoing with other bisphenol polycarbonates, are supplied by Bayer Co. under the APEC® trade name.

In further aspects, additional useful dihydroxy compounds are those compounds having the formula HO—R¹—OH include aromatic dihydroxy compounds of formula (7):

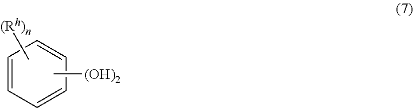

wherein each R^{h} is independently a halogen atom, a C₁₋₁₀ hydrocarbyl such as a C₁₋₁₀ alkyl group, a halogen substituted C₁₋₁₀ hydrocarbyl such as a halogen-substituted C₁₋₁₀ alkyl group, and n is 0 to 4. The halogen is usually bromine.

In addition to the polycarbonates described above, combinations of the polycarbonate with other thermoplastic polymers, for example combinations of homopolycarbonates and/or polycarbonate copolymers, can be used.

In various aspects, a polycarbonate can employ two or more different dihydroxy compounds or a copolymer of a dihydroxy compounds with a glycol or with a hydroxy- or acid-terminated polyester or with a dibasic acid or hydroxy acid in the event a carbonate copolymer rather than a homopolymer is desired for use. Polyarylates and polyester-carbonate resins or their blends can also be employed. Branched polycarbonates are also useful, as well as blends of linear polycarbonate and a branched polycarbonate. The branched polycarbonates can be prepared by adding a branching agent during polymerization.

In a further aspect, the branching agents include polyfunctional organic compounds containing at least three functional groups selected from hydroxyl, carboxyl, carboxylic anhydride, haloformyl, and mixtures thereof. Non-limiting examples include trimellitic acid, trimellitic anhydride, trimellitic trichloride, tris-p-hydroxy phenyl ethane, isatin-bis-phenol, tris-phenol TC (1,3,5-tris((p-hydroxyphenyl)isopropyl)benzene), tris-phenol PA (4(4(1,1-bis(p-hydroxyphenyl)-ethyl)alpha,alpha-dimethyl benzyl)phenol), 4-chloroformyl phthalic anhydride, trimesic acid, and benzophenone tetracarboxylic acid. The branching agents can be added at a level of from 0.05-2.0 weight percent. Branching agents and procedures for making branched polycarbonates are described in U.S. Pat. Nos. 3,635,895 and 4,001,184. All types of polycarbonate end groups are contemplated as being useful in the thermoplastic composition.

In a further aspect, the polycarbonate can be a linear homopolymer derived from bisphenol A, in which each of A¹ and A² is p-phenylene and Y¹ is isopropylidene. The polycarbonates generally can have an intrinsic viscosity, as determined in chloroform at 25° C., of 0.3 to 1.5 deciliters per gram (dl/g), for example 0.45 to 1.0 dl/g. The polycarbonates can have a weight average molecular weight (Mw) of 10,000 to 100,000 g/mol, as measured by gel permeation chromatography (GPC) using a crosslinked styrene-divinyl benzene column, at a sample concentration of 1 milligram per milliliter, and as calibrated with polycarbonate standards. In a yet further aspect, the polycarbonate has an Mw of about 15,000 to about 55,000. In an even further aspect, the polycarbonate has an Mw of about 18,000 to about 40,000.

In a further aspect, a polycarbonate component used in the formulations of the present invention can have a melt volume flow rate (often abbreviated MVR) measures the rate of extrusion of a thermoplastics through an orifice at a prescribed temperature and load. Polycarbonates useful for the formation of articles can have an MVR, measured at 300° C. under a load of 1.2 kg according to ASTM D1238-04 or ISO 1133, of 0.5 to 80 cubic centimeters per 10 minutes (cc/10 min). In a still further aspect, the polycarbonate component comprises a two polycarbonate polymers wherein one of the polycarbonate polymers is a poly(aliphatic ester)-polycarbonate. In cases where the polycarbonate components comprises a non-poly(aliphatic ester)-polycarbonate and a poly(aliphatic ester)-polycarbonate, the non-poly(aliphatic ester)-polycarbonate (or a combination of such polycarbonates) can have a MVR measured at 300° C. under a load of 1.2 kg according to ASTM D1238-04 or ISO 1133, of 45 to 75 cc/10 min, including, for example 50 to 70 cc/10 min, and 55 to 65 cc/10 min.

Polycarbonates, including isosorbide-based polyester-polycarbonate, can comprise copolymers comprising carbonate units and other types of polymer units, including ester units, and combinations comprising at least one of homopolycarbonates and copolycarbonates. An exemplary polycarbonate copolymer of this type is a polyester carbonate, also known as a polyester-polycarbonate or polyester carbonate. Such copolymers further contain carbonate units derived from oligomeric ester-containing dihydroxy compounds (also referred to herein as hydroxy end-capped oligomeric acrylate esters).

In various further aspects, “polycarbonates” and “polycarbonate resins” as used herein further include homopolycarbonates, copolymers comprising different R¹ moieties in the carbonate (referred to herein as “copolycarbonates”), copolymers comprising carbonate units and other types of polymer units, such as ester units, polysiloxane units, and combinations comprising at least one of homopolycarbonates and copolycarbonates. As used herein, “combination” is inclusive of blends, mixtures, alloys, reaction products, and the like. A specific type of copolymer is a polyester carbonate, also known as a polyester-polycarbonate. Such copolymers further contain, in addition to recurring carbonate chain units of the formula (1), units of formula (8):

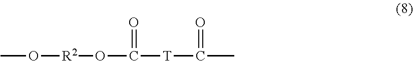

wherein R² is a divalent group derived from a dihydroxy compound, and can be, for example, a C₂₋₁₀ alkylene group, a C₆₋₂₀ alicyclic group, a C₆₋₂₀ aromatic group or a polyoxyalkylene group in which the alkylene groups contain 2 to about 6 carbon atoms, including, for example 2, 3, or 4 carbon atoms; and T is a divalent group derived from a dicarboxylic acid (aliphatic, aromatic, or alkyl aromatic), and can be, for example, a C₄₋₁₈ aliphatic group, a C₆₋₂₀ alkylene group, a C₆₋₂₀ alkylene group, a C₆₋₂₀ alicyclic group, a C₆₋₂₀ alkyl aromatic group, or a C₆₋₂₀ aromatic group. R² can be is a C₂₋₃₀ alkylene group having a straight chain, branched chain, or cyclic (including polycyclic) structure. Alternatively, R² can be derived from an aromatic dihydroxy compound of formula (4) above, or from an aromatic dihydroxy compound of formula (7) above.

Examples of aromatic dicarboxylic acids that can be used to prepare the polyester units include isophthalic or terephthalic acid, 1,2-di(p-carboxyphenyl)ethane, 4,4′-dicarboxydiphenyl ether, 4,4′-bisbenzoic acid, and combinations comprising at least one of the foregoing acids. Acids containing fused rings can also be present, such as in 1,4-, 1,5-, or 2,6-naphthalenedicarboxylic acids. Examples of specific dicarboxylic acids are terephthalic acid, isophthalic acid, naphthalene dicarboxylic acid, cyclohexane dicarboxylic acid, or combinations thereof. In various aspects, an example of a specific dicarboxylic acid comprises a combination of isophthalic acid and terephthalic acid wherein the weight ratio of isophthalic acid to terephthalic acid is about 91:9 to about 2:98. In another aspect, R² is a C₂₋₆ alkylene group and T is p-phenylene, m-phenylene, naphthalene, a divalent cycloaliphatic group, or a combination thereof. This class of polyester includes the poly(alkylene terephthalates).

The molar ratio of ester units to carbonate units in the copolymers can vary broadly, for example 1:99 to 99:1, including, for example 10:90 to 90:10, and 25:75 to 75:25, depending on the desired properties of the final composition.

In a further aspect, the thermoplastic composition comprises a polyester-polycarbonate copolymer, and including, for example a polyester-polycarbonate copolymer in which the ester units of formula (8) comprise soft block ester units, also referred to herein as aliphatic dicarboxylic acid ester units. Such a polyester-polycarbonate copolymer comprising soft block ester units is also referred to herein as a poly(aliphatic ester)-polycarbonate. The soft block ester unit can be a C₆₋₂₀ aliphatic dicarboxylic acid ester unit (where C₆₋₂₀ includes the terminal carboxyl groups), and can be straight chain (i.e., unbranched) or branched chain dicarboxylic acids, cycloalkyl or cycloalkylidene-containing dicarboxylic acids units, or combinations of these structural units. In a still further aspect, the C₆₋₂₀ aliphatic dicarboxylic acid ester unit includes a straight chain alkylene group comprising methylene (—CH₂—) repeating units. In a yet further aspect, a useful soft block ester unit comprises units of formula (8a):

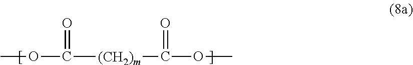

where m is 4 to 18. In a further aspect of formula (8a), m is 8 to 10. The poly(aliphatic ester)-polycarbonate can include less than or equal to 25 wt % of the soft block unit. In a still further aspect, a poly(aliphatic ester)-polycarbonate comprises units of formula (8a) in an amount of 0.5 to 10 wt %, including, for example 1 to 9 wt %, and more including, for example 3 to 8 wt %, based on the total weight of the poly(aliphatic ester)-polycarbonate.

The poly(aliphatic ester)-polycarbonate is a copolymer of soft block ester units and carbonate units. The poly(aliphatic ester)-polycarbonate is shown in formula (8b):

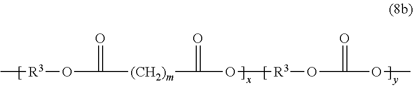

where each R³ is independently derived from a dihydroxyaromatic compound of formula (4) or (7), m is 4 to 18, and x and y each represent average weight percentages of the poly(aliphatic ester)-polycarbonate where the average weight percentage ratio x:y is 10:90 to 0.5:99.5, including, for example 9:91 to 1:99, and 8:92 to 3:97, where x+y is 100.

Soft block ester units, as defined herein, can be derived from an alpha, omega C₆₋₂₀ aliphatic dicarboxylic acid or a reactive derivative thereof. In a further aspect, the soft block ester units can be derived from an alpha, omega C₁₀₋₁₂ aliphatic dicarboxylic acid or a reactive derivative thereof. In a still further aspect, the carboxylate portion of the aliphatic ester unit of formula (8a), in which the terminal carboxylate groups are connected by a chain of repeating methylene (—CH₂—) units (where m is as defined for formula (8a)), is derived from the corresponding dicarboxylic acid or reactive derivative thereof, such as the acid halide (for example, the acid chloride), an ester, or the like. Exemplary alpha, omega dicarboxylic acids (from which the corresponding acid chlorides can be derived) include alpha, omega C₆ dicarboxylic acids such as hexanedioic acid (also referred to as adipic acid); alpha, omega C₁₀ dicarboxylic acids such as decanedioic acid (also referred to as sebacic acid); and alpha, omega C₁₂ dicarboxylic acids such as dodecanedioic acid (sometimes abbreviated as DDDA). It will be appreciated that the aliphatic dicarboxylic acid is not limited to these exemplary carbon chain lengths, and that other chain lengths within the C₆₋₂₀ limitation can be used. In various further aspects, the poly(aliphatic ester)-polycarbonate having soft block ester units comprising a straight chain methylene group and a bisphenol A polycarbonate group is shown in formula (8c):

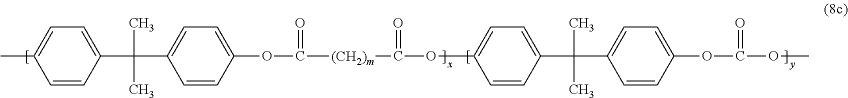

where m is 4 to 18 and x and y are as defined for formula (8b). In a specific exemplary aspect, a useful poly(aliphatic ester)-polycarbonate copolymer comprises sebacic acid ester units and bisphenol A carbonate units (formula (8c), where m is 8, and the average weight ratio of x:y is 6:94).

Desirably, the poly(aliphatic ester)-polycarbonate has a glass transition temperature (Tg) of 110 to 145° C., including, for example 115 to 145° C., and 120 to 145° C., and 128 to 139° C., and 130 to 139° C.

In one aspect, polycarbonates, including polyester-polycarbonates, can be manufactured by processes such as interfacial polymerization and melt polymerization.

The polycarbonate compounds and polymers disclosed herein can, in various aspects, be prepared by a melt polymerization process. Generally, in the melt polymerization process, polycarbonates are prepared by co-reacting, in a molten state, the dihydroxy reactant(s) (i.e., isosorbide, aliphatic diol and/or aliphatic diacid, and any additional dihydroxy compound) and a diaryl carbonate ester, such as diphenyl carbonate, or in an further aspect, an activated carbonate such as bis(methyl salicyl)carbonate, in the presence of a transesterification catalyst. The reaction can be carried out in typical polymerization equipment, such as one or more continuously stirred reactors (CSTRs), plug flow reactors, wire wetting fall polymerizers, free fall polymerizers, wiped film polymerizers, BANBURY® mixers, single or twin screw extruders, or combinations of the foregoing. In one aspect, volatile monohydric phenol can be removed from the molten reactants by distillation and the polymer is isolated as a molten residue.

In one aspect, an end-capping agent (also referred to as a chain-stopper) can optionally be used to limit molecular weight growth rate, and so control molecular weight in the polycarbonate. Exemplary chain-stoppers include certain monophenolic compounds (i.e., phenyl compounds having a single free hydroxy group), monocarboxylic acid chlorides, and/or monochloroformates. Phenolic chain-stoppers are exemplified by phenol and C₁-C₂₂ alkyl-substituted phenols such as p-cumyl-phenol, resorcinol monobenzoate, and p- and tertiary-butyl phenol, cresol, and monoethers of diphenols, such as p-methoxyphenol. Alkyl-substituted phenols with branched chain alkyl substituents having 8 to 9 carbon atoms can be specifically mentioned.

Polycarbonates, including polyester-polycarbonates, can be also be manufactured by interfacial polymerization. Although the reaction conditions for interfacial polymerization can vary, an exemplary process generally involves dissolving or dispersing a dihydric phenol reactant in aqueous caustic soda or potash, adding the resulting mixture to a suitable water-immiscible solvent medium, and contacting the reactants with a carbonate precursor in the presence of a catalyst such as triethylamine or a phase transfer catalyst, under controlled pH conditions, e.g., about 8 to about 10. The most commonly used water immiscible solvents include methylene chloride, 1,2-dichloroethane, chlorobenzene, toluene, and the like.

Carbonate precursors include, for example, a carbonyl halide such as carbonyl bromide or carbonyl chloride, or a haloformate such as a bishaloformates of a dihydric phenol (e.g., the bischloroformates of bisphenol A, hydroquinone, or the like) or a glycol (e.g., the bishaloformate of ethylene glycol, neopentyl glycol, polyethylene glycol, or the like). Combinations comprising at least one of the foregoing types of carbonate precursors can also be used. In an exemplary aspect, an interfacial polymerization reaction to form carbonate linkages uses phosgene as a carbonate precursor, and is referred to as a phosgenation reaction.

All types of polycarbonate end groups are contemplated as being useful in the polycarbonate composition, provided that such end groups do not significantly adversely affect desired properties of the compositions.

Branched polycarbonate blocks can be prepared by adding a branching agent during polymerization. These branching agents include polyfunctional organic compounds containing at least three functional groups selected from hydroxyl, carboxyl, carboxylic anhydride, haloformyl, and mixtures of the foregoing functional groups. Specific examples include trimellitic acid, trimellitic anhydride, trimellitic trichloride, tris-p-hydroxy phenyl ethane, isatin-bis-phenol, tris-phenol TC (1,3,5-tris((p-hydroxyphenyl)isopropyl)benzene), tris-phenol PA (4(4(1,1-bis(p-hydroxyphenyl)-ethyl)alpha,alpha-dimethyl benzyl)phenol), 4-chloroformyl phthalic anhydride, trimesic acid, and benzophenone tetracarboxylic acid. The branching agents can be added at a level of about 0.05 to about 2.0 wt %. Mixtures comprising linear polycarbonates and branched polycarbonates can be used.

The polyesters can be obtained by interfacial polymerization or melt-process condensation as described above, by solution phase condensation, or by transesterification polymerization wherein, for example, a dialkyl ester such as dimethyl terephthalate can be transesterified with ethylene glycol using acid catalysis, to generate poly(ethylene terephthalate). It is possible to use a branched polyester in which a branching agent, for example, a glycol having three or more hydroxyl groups or a trifunctional or multifunctional carboxylic acid has been incorporated. Furthermore, it is sometime desirable to have various concentrations of acid and hydroxyl end groups on the polyester, depending on the ultimate end use of the composition.

Polyester-polycarbonate copolymers generally can have a weight average molecular weight (Mw) of 1,500 to 100,000 g/mol, including, for example 1,700 to 50,000 g/mol. In an aspect, poly(aliphatic ester)-polycarbonates have a molecular weight of 15,000 to 45,000 g/mol, including, for example 17,000 to 40,000 g/mol, and 20,000 to 30,000 g/mol, and 20,000 to 25,000 g/mol. Molecular weight determinations are performed using gel permeation chromatography (GPC), using a crosslinked styrene-divinylbenzene column and calibrated to polycarbonate references. Samples are prepared at a concentration of about 1 mg/ml, and are eluted at a flow rate of about 1.0 ml/min.

A polyester-polycarbonate can in general have an MVR of about 5 to about 150 cc/10 min., including, for example about 7 to about 125 cc/10 min, and about 9 to about 110 cc/10 min, and about 10 to about 100 cc/10 min, measured at 300° C. and a load of 1.2 kilograms according to ASTM D1238-04 or ISO 1133. Commercial polyester blends with polycarbonate are marketed under the trade name XYLEX®, including for example XYLEX® X7300, and commercial polyester-polycarbonates are marketed under the trade name LEXAN® SLX polymers, including for example LEXAN® SLX-9000, and are available from SABIC Innovative Plastics (formerly GE Plastics).

In an aspect, poly(aliphatic ester)-polycarbonates have an MVR of about 13 to about 25 cc/10 min, for example, about 15 to about 22 cc/10 min, measured at 250° C. and under a load of 1.2 kilograms and a dwell time of 6 minutes, according to ASTM D1238-04. Also in an aspect, poly(aliphatic ester)-polycarbonates have an MVR of about 13 to about 25 cc/10 min, for example, about 15 to about 22 cc/10 min, measured at 250° C. and under a load of 1.2 kilograms and a dwell time of 4 minutes, according to ISO 1133.

In an aspect, the thermoplastic composition comprises poly(aliphatic ester)-polycarbonate in an amount of 50 to 100 wt %, based on the total weight of poly(aliphatic ester)-polycarbonate and any added polycarbonate. In a specific aspect, the thermoplastic composition comprises only poly(aliphatic ester)-polycarbonate. In another specific aspect, the thermoplastic comprises poly(aliphatic ester)-polycarbonate that has been reactively extruded to form a reaction product. In another specific aspect, the thermoplastic comprises a blend of poly(aliphatic ester)-polycarbonate that has been reactively extruded.

In a further aspect, the polycarbonate polymer is a homopolymer. In a still further aspect, the homopolymer comprises repeating units derived from bisphenol A.

In a further aspect, the polycarbonate is a copolymer. In a still further aspect, the copolymer comprises repeating units derived from BPA. In yet a further aspect, the copolymer comprises repeating units derived from sebacic acid. In an even further aspect, the copolymer comprises repeating units derived from sebacic acid and BPA.

In a further aspect, the polycarbonate has a weight average molecular weight from about 15,000 to about 50,000 grams/mole, as measured by gel permeation chromatography using BPA polycarbonate standards. In a still further aspect, the polycarbonate has a weight average molecular weight from about 18,000 to about 40,000 grams/mole, as measured by gel permeation chromatography using BPA polycarbonate standards. In yet a further aspect, the polycarbonate has a weight average molecular weight from about 18,000 to about 30,000 grams/mole, as measured by gel permeation chromatography using BPA polycarbonate standards.

In a further aspect, the polycarbonate polymer is present in an amount from greater than 0 wt % to about 99 wt %, relative to the total weight of the composition, including exemplary values of 5 wt %, 10 wt %, 15 wt %, 20 wt %, 25 wt %, 30 wt %, 35 wt %, 40 wt %, 45 wt %, 50 wt %, 55 wt %, 60 wt %, 65 wt %, 70 wt %, 75 wt %, 80 wt %, 85 wt %, 90 wt %, and 95 wt %. In further aspects, the weight percentage can be in a range derived from any two of the above listed exemplary wt % values. In a still further aspect, the polycarbonate polymer of the fiber reinforced thermoplastic resin composition is present in an amount ranging from 5 wt % to about 95 wt %, relative to the total weight of the composition. In a yet further aspect, the polycarbonate polymer of the fiber reinforced thermoplastic resin composition is present in an amount ranging from 30 wt % to about 95 wt %, relative to the total weight of the composition. In an even further aspect, the polycarbonate polymer of the fiber reinforced thermoplastic resin composition is present in an amount from 50 wt % to about 95 wt %. In a still further aspect, the polycarbonate polymer of the fiber reinforced thermoplastic resin composition is present in an amount ranging from greater than 50 wt % to about 90 wt %, relative to the total weight of the composition. In yet further aspect, the polycarbonate polymer of the fiber reinforced thermoplastic resin composition is present in an amount from 60 wt % to about 90 wt %.

In a further aspect, the polycarbonate polymer comprises a blend of at least two polycarbonate polymers. In a still further aspect, the polycarbonate polymer comprises a first polycarbonate polymer component and a second polycarbonate polymer component.

In a further aspect, the polycarbonate polymer further comprises a copolymer. Useful polycarbonate copolymers are commercially available and include, but are not limited to, those marketed under the trade names LEXAN® EXL and LEXAN® HFD polymers, and are available from SABIC Innovative Plastics (formerly GE Plastics).

In a further aspect, the first polycarbonate polymer component is a high flow polycarbonate. In a still further aspect, the first polycarbonate polymer component has a melt volume flow rate (MVR) from about 17 cc/10 minutes to about 50 cc/10 minutes when measured at 300° C. and under a load of 1.2 kg according to ASTM D1238. In yet a further aspect, the first polycarbonate polymer component has a melt volume flow rate (MVR) from about 20 cc/10 minutes to about 45 cc/10 minutes when measured at 300° C. and under a load of 1.2 kg according to ASTM D1238. In an even further aspect, the first polycarbonate polymer component has a melt volume flow rate (MVR) from about 22 cc/10 minutes to about 40 cc/10 minutes when measured at 300° C. and under a load of 1.2 kg according to ASTM D1238.

In a further aspect, the first polycarbonate polymer component has a weight average molecular weight from about 18,000 to about 40,000 grams/mole, as measured by gel permeation chromatography using BPA polycarbonate standards. In a still further aspect, the first polycarbonate polymer component has a weight average molecular weight from about 18,000 to about 30,000 grams/mole, as measured by gel permeation chromatography using BPA polycarbonate standards. In yet a further aspect, the first polycarbonate polymer component has a weight average molecular weight from about 18,000 to about 25,000 grams/mole, as measured by gel permeation chromatography using BPA polycarbonate standards. In an even further aspect, the first polycarbonate polymer component has a weight average molecular weight from about 18,000 to about 25,000 grams/mole, as measured by gel permeation chromatography using BPA polycarbonate standards.

In a further aspect, the second polycarbonate polymer component is a low flow polycarbonate. In a still further aspect, the second polycarbonate polymer component has a melt volume flow rate (MVR) from about 1.0 cc/10 minutes to about 8.0 cc/10 minutes when measured at 300° C. and under a load of 1.2 kg according to ASTM D1238. In yet a further aspect, the second polycarbonate polymer component has a melt volume flow rate (MVR) from about 1 cc/10 minutes to about 7.2 cc/10 minutes when measured at 300° C. and under a load of 1.2 kg according to ASTM D1238. In an even further aspect, the second polycarbonate polymer component has a melt volume flow rate (MVR) from about 1 cc/10 minutes to about 7.1 cc/10 minutes when measured at 300° C. and under a load of 1.2 kg according to ASTM D1238.

In a further aspect, the second polycarbonate polymer component has a weight average molecular weight from about 18,000 to about 40,000 grams/mole, as measured by gel permeation chromatography using BPA polycarbonate standards. In a still further aspect, the second polycarbonate polymer component has a weight average molecular weight from about 20,000 to about 35,000 grams/mole, as measured by gel permeation chromatography using BPA polycarbonate standards. In yet a further aspect, the second polycarbonate polymer component has a weight average molecular weight from about 20,000 to about 30,000 grams/mole, as measured by gel permeation chromatography using BPA polycarbonate standards. In an even further aspect, the second polycarbonate polymer component has a weight average molecular weight from about 23,000 to about 30,000 grams/mole, as measured by gel permeation chromatography using BPA polycarbonate standards. In a still further aspect, the second polycarbonate polymer component has a weight average molecular weight from about 25,000 to about 30,000 grams/mole, as measured by gel permeation chromatography using BPA polycarbonate standards. In yet a further aspect, the second polycarbonate polymer component has a weight average molecular weight from about 27,000 to about 30,000 grams/mole, as measured by gel permeation chromatography using BPA polycarbonate standards.

2. Polyester Polymer

In a further aspect, the polycarbonate polymer further comprises a copolymer. Useful polycarbonate copolymers are commercially available and include, but are not limited to, those marketed under the trade names LEXAN® EXL and LEXAN® HFD polymers, and are available from SABIC Innovative Plastics (formerly GE Plastics).

In one aspect, the disclosed fiber reinforced thermoplastic compositions comprise a polyester polymer component. Polyesters having repeating units of formula (8):

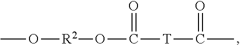

which include poly(alkylene dicarboxylates), liquid crystalline polyesters, and polyester copolymers, are generally useful in the disclosed thermoplastic compositions of the present invention. The polyesters described herein are generally completely miscible with the polycarbonates when blended.

Such polyesters generally include aromatic polyesters, poly(alkylene esters) including poly(alkylene arylates), and poly(cycloalkylene diesters). Aromatic polyesters can have a polyester structure according to formula (8), wherein D and T are each aromatic groups as described hereinabove. In an aspect, useful aromatic polyesters can include, for example, poly(isophthalate-terephthalate-resorcinol)esters, poly(isophthalate-terephthalate-bisphenol A)esters, poly[(isophthalate-terephthalate-resorcinol)ester-co-(isophthalate-terephthalate-bisphenol A)]ester, or a combination comprising at least one of these. Also contemplated are aromatic polyesters with a minor amount, e.g., about 0.5 to about 10 wt %, based on the total weight of the polyester, of units derived from an aliphatic diacid and/or an aliphatic polyol to make copolyesters. Poly(alkylene arylates) can have a polyester structure according to formula (8), wherein T comprises groups derived from aromatic dicarboxylates, cycloaliphatic dicarboxylic acids, or derivatives thereof. Examples of useful T groups include 1,2-, 1,3-, and 1,4-phenylene; 1,4- and 1,5-naphthylenes; cis- or trans-1,4-cyclohexylene; and the like. Where T is 1,4-phenylene, the poly(alkylene arylate) is a poly(alkylene terephthalate). In addition, for poly(alkylene arylate), useful alkylene groups D include, for example, ethylene, 1,4-butylene, and bis-(alkylene-disubstituted cyclohexane) including cis- and/or trans-1,4-(cyclohexylene)dimethylene. Examples of poly(alkylene terephthalates) include poly(ethylene terephthalate) (PET), poly(1,4-butylene terephthalate) (PBT), and poly(propylene terephthalate) (PPT). Also useful are poly(alkylene naphthoates), such as poly(ethylene naphthanoate) (PEN), and poly(butylene naphthanoate) (PBN). A useful poly(cycloalkylene diester) is poly(cyclohexanedimethylene terephthalate) (PCT). Combinations comprising at least one of the foregoing polyesters can also be used.

Copolymers comprising alkylene terephthalate repeating ester units with other ester groups can also be useful. Useful ester units can include different alkylene terephthalate units, which can be present in the polymer chain as individual units, or as blocks of poly(alkylene terephthalates). Specific examples of such copolymers include poly(cyclohexanedimethylene terephthalate)-co-poly(ethylene terephthalate), abbreviated as PETG where the polymer comprises greater than or equal to 50 mol % of poly(ethylene terephthalate), and abbreviated as PCTG where the polymer comprises greater than 50 mol % of poly(1,4-cyclohexanedimethylene terephthalate).

Poly(cycloalkylene diester)s can also include poly(alkylene cyclohexanedicarboxylate)s. Of these, a specific example is poly(1,4-cyclohexane-dimethanol-1,4-cyclohexanedicarboxylate) (PCCD), having recurring units of formula (9):

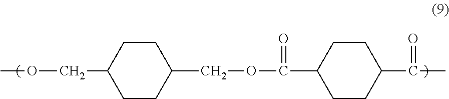

wherein, as described using formula (8), R² is a 1,4-cyclohexanedimethylene group derived from 1,4-cyclohexanedimethanol, and T is a cyclohexane ring derived from cyclohexanedicarboxylate or a chemical equivalent thereof, and can comprise the cis-isomer, the trans-isomer, or a combination comprising at least one of the foregoing isomers.

The polyesters can be obtained by interfacial polymerization or melt-process condensation as described above, by solution phase condensation, or by transesterification polymerization wherein, for example, a dialkyl ester such as dimethyl terephthalate can be transesterified with ethylene glycol using acid catalysis, to generate poly(ethylene terephthalate). It is possible to use a branched polyester in which a branching agent, for example, a glycol having three or more hydroxyl groups or a trifunctional or multifunctional carboxylic acid has been incorporated. Furthermore, it is sometime desirable to have various concentrations of acid and hydroxyl end groups on the polyester, depending on the ultimate end use of the composition.

In a further aspect, the polyester polymer is polybutylene terephthalate.

In a further aspect, the polyester polymer is polyethylene terephthalate.

In a further aspect, the polyester polymer is present in an amount from greater than 0 wt % to about 99 wt %, relative to the total weight of the composition, including exemplary values of 5 wt %, 10 wt %, 15 wt %, 20 wt %, 25 wt %, 30 wt %, 35 wt %, 40 wt %, 45 wt %, 50 wt %, 55 wt %, 60 wt %, 65 wt %, 70 wt %, 75 wt %, 80 wt %, 85 wt %, 90 wt %, and 95 wt %. In further aspects, the weight percentage can be in a range derived from any two of the above listed exemplary wt % values. In a still further aspect, the polyester polymer of the fiber reinforced thermoplastic resin composition is present in an amount ranging from 5 wt % to about 95 wt %, relative to the total weight of the composition. In a yet further aspect, the polyester polymer of the fiber reinforced thermoplastic resin composition is present in an amount ranging from 30 wt % to about 95 wt %, relative to the total weight of the composition. In an even further aspect, the polyester polymer of the fiber reinforced thermoplastic resin composition is present in an amount from 50 wt % to about 95 wt %. In a still further aspect, the polyester polymer of the fiber reinforced thermoplastic resin composition is present in an amount ranging from greater than 50 wt % to about 90 wt %, relative to the total weight of the composition. In yet further aspect, the polyester polymer of the fiber reinforced thermoplastic resin composition is present in an amount from 60 wt % to about 90 wt %.

In a further aspect, the thermoplastic polymer component comprises a blend of at least two thermoplastic polymers. In a still further aspect, the thermoplastic polymer component comprises a blend of a polycarbonate polymer and a polyester polymer. In a yet further aspect, the thermoplastic polymer component comprise a polycarbonate/polyalkylene terephthalate (PC/PAT) blend. In an even further aspect, the thermoplastic polymer component is a polycarbonate/polybutylene terephthalate (PC/PBT) blend.

In a further aspect, the thermoplastic polymer component is present in an amount from greater than 0 wt % to about 99 wt %, relative to the total weight of the composition, including exemplary values of 5 wt %, 10 wt %, 15 wt %, 20 wt %, 25 wt %, 30 wt %, 35 wt %, 40 wt %, 45 wt %, 50 wt %, 55 wt %, 60 wt %, 65 wt %, 67 wt %, 70 wt %, 75 wt %, 80 wt %, 85 wt %, 90 wt %, and 95 wt %. In further aspects, the weight percentage can be in a range derived from any two of the above listed exemplary wt % values. In a still further aspect, the thermoplastic polymer component of the fiber reinforced thermoplastic resin composition is present in an amount ranging from 5 wt % to about 95 wt %, relative to the total weight of the composition. In a yet further aspect, the thermoplastic polymer component of the fiber reinforced thermoplastic resin composition is present in an amount ranging from 30 wt % to about 95 wt %, relative to the total weight of the composition. In an even further aspect, the thermoplastic polymer component of the fiber reinforced thermoplastic resin composition is present in an amount from 50 wt % to about 95 wt %. In a still further aspect, the thermoplastic polymer component of the fiber reinforced thermoplastic resin composition is present in an amount ranging from greater than 50 wt % to about 90 wt %, relative to the total weight of the composition. In yet further aspect, the thermoplastic polymer component of the fiber reinforced thermoplastic resin composition is present in an amount from 60 wt % to about 90 wt %.

3. Maleic Anhydride Additive Component

In one aspect, the disclosed fiber reinforced thermoplastic resin composition of the present invention comprises at least one maleic anhydride (MAH) additive component. In further aspects, the maleic anhydride additive component comprises a copolymer grafted with maleic anhydride. In still further aspects, the maleic anhydride additive component comprises a polypropylene random copolymer highly grafted with maleic anhydride. In even further aspects, the maleic anhydride additive component is FUSABOND P353 (DuPont).

In another aspect, the maleic anhydride additive component is present in an amount ranging from greater than 0 wt % to about 10 wt % relative to the total weight of the composition, including exemplary values, 0.5 wt %, 1 wt %, 2 wt %, 3 wt %, 4 wt %, 5 wt %, 6 wt %, 7 wt %, 8 wt %, and 9 wt %. In still further aspects, the weight percentage can be in a range derived from any two of the above listed exemplary wt % values. For example, the reinforcement fiber component is present in an amount ranging from 1 to 6 wt %, or from 2 to 4 wt % relative to the total weight of the composition.

4. Reinforcement Fiber Component

In one aspect, the disclosed fiber reinforced thermoplastic resin composition of the present invention comprises at least one reinforcement fiber component. In further aspects, the reinforcement fiber component comprises a carbon fibers. In still further aspects, the reinforcement fiber component comprises polyacrylonitrile (PAN) based carbon fibers.

In some aspects, the reinforcement fiber component comprises carbon fibers having a tensile modulus in the range of from 28 to 48 MSI, including exemplary values of 29, 30, 31, 32, 33, 34, 35, 36, 37, 38, 39, 40, 41, 42, 43, 44, 45, 46, and 47 MSI. In further aspects, the tensile modulus can be in a range derived from any two of the above listed exemplary values, for example, the reinforcement fiber component can comprise carbon fibers having a tensile modulus in the range of from 32 to 45 MSI, or tensile modulus in the range of from 35 to 42 MSI.

In other aspects, the reinforcement fiber component comprises carbon fibers having a tensile strength in the range of from 400 to 1200 MSI, including exemplary values of 500, 600, 700, 800, 900, 1000, and 1100 MSI. In further aspects, the tensile strength can be in a range derived from any two of the above listed exemplary values, for example, the reinforcement fiber component can comprise carbon fibers having a tensile strength in the range of from 500 to 1000 MSI, or tensile strength in the range of from 700 to 900 MSI.

Non-limiting examples of commercially available carbon fibers include HexTow® IM7, commercially available from the Hexcel Corporation, and having a tensile modulus of about 40 MSI and TORAYCA® T800S, commercially available from Toray Carbon Fibers America, Inc., (a wholly owned subsidiary of Toray Industries, Inc.) and having a tensile modulus of about 42 MSI.

In a further aspect, the fiber reinforcement component is present in an amount from greater than 0 wt % to about 70 wt %, relative to the total weight of the composition, including exemplary values of 5 wt %, 10 wt %, 15 wt %, 20 wt %, 25 wt %, 30 wt %, 35 wt %, 40 wt %, 45 wt %, 50 wt %, 55 wt %, 60 wt %, and 65 wt %. In further aspects, the weight percentage can be in a range derived from any two of the above listed exemplary wt % values. In a still further aspect, the fiber reinforcement component of the fiber reinforced thermoplastic resin composition is present in an amount ranging from greater than 0 wt % to about 60 wt %, relative to the total weight of the composition. In a yet further aspect, the fiber reinforcement component of the fiber reinforced thermoplastic resin composition is present in an amount ranging from greater than 0 wt % to about 50 wt %, relative to the total weight of the composition. In an even further aspect, the fiber reinforcement component of the fiber reinforced thermoplastic resin composition is present in an amount from greater than 0 wt % to about 30 wt %.

In another aspect, the reinforcement fiber component is present in an amount ranging from 1 wt % to 40 wt % relative to the total weight of the composition, including exemplary values, 2 wt %, 4 wt %, 5 wt %, 10 wt %, 12 wt %, 15 wt %, 20 wt %, 25 wt %, 30 wt %, 33 wt %, 35 wt %, and 38 wt %. In still further aspects, the weight percentage can be in a range derived from any two of the above listed exemplary wt % values. For example, the reinforcement fiber component is present in an amount ranging from 15 to 30 wt % relative to the total weight of the composition.

5. Other Additives for Blended Thermoplastic Compositions

In various aspects, the fiber reinforced thermoplastic resin composition of the present invention further comprises an additive selected from coupling agents, antioxidants, mold release agents, UV absorbers, light stabilizers, heat stabilizers, lubricants, plasticizers, pigments, dyes, colorants, anti-static agents, nucleating agents, anti-drip agents, acid scavengers, and combinations of two or more of the foregoing. In a further aspect, the fiber reinforced thermoplastic resin composition of the present invention further comprises at least one polymer additive.

In addition to the foregoing components, the disclosed fiber reinforced thermoplastic resin composition can optionally comprise a balance amount of one or more additive materials ordinarily incorporated in thermoplastic resin compositions of this type, with the proviso that the additives are selected so as to not significantly adversely affect the desired properties of the fiber reinforced thermoplastic resin composition. Combinations of additives can be used. Such additives can be mixed at a suitable time during the mixing of the components for forming the composition. Exemplary and non-limiting examples of additive materials that can be present in the fiber reinforced thermoplastic resin compositions include an antioxidant, a stabilizer (including for example a heat stabilizer, a hydrolytic stabilizer, or a light stabilizer), UV absorbing additive, plasticizer, lubricant, mold release agent, antistatic agent, colorant (e.g., pigment and/or dye), or any combination thereof.

In a further aspect, the thermoplastic compositions can further comprise a primary antioxidant or “stabilizer” (e.g., a hindered phenol) and, optionally, a secondary antioxidant (e.g., a phosphate and/or thioester). Suitable antioxidant additives include, for example, alkylated monophenols or polyphenols; alkylated reaction products of polyphenols with dienes, such as tetrakis[methylene(3,5-di-tert-butyl-4-hydroxyhydrocinnamate)]methane, or the like; butylated reaction products of para-cresol or dicyclopentadiene; alkylated hydroquinones; hydroxylated thiodiphenyl ethers; alkylidene-bisphenols; benzyl compounds; esters of beta-(3,5-di-tert-butyl-4-hydroxyphenyl)-propionic acid with monohydric or polyhydric alcohols; esters of beta-(5-tert-butyl-4-hydroxy-3-methylphenyl)-propionic acid with monohydric or polyhydric alcohols; esters of thioalkyl or thioaryl compounds such as distearylthiopropionate, dilaurylthiopropionate, ditridecylthiodipropionate, octadecyl-3-(3,5-di-tert-butyl-4-hydroxyphenyl)propionate, pentaerythrityl-tetrakis[3-(3,5-di-tert-butyl-4-hydroxyphenyl)propionate or the like; amides of beta-(3,5-di-tert-butyl-4-hydroxyphenyl)-propionic acid or the like, or combinations comprising at least one of the foregoing antioxidants. Antioxidants are generally used in amounts of about 0.01 wt % to about 1 wt %, optionally about 0.05 wt % to about 0.5 wt % of the blend composition.

In various aspects, the thermoplastic composition further comprises a hydrolytic stabilizer, wherein the hydrolytic stabilizer comprises a hydrotalcite and an inorganic buffer salt. In a further aspect, the thermoplastic blend composition comprises a hydrolytic stabilizer, wherein the hydrolytic stabilizer comprises one or more hydrotalcites and an inorganic buffer salt comprising one or more inorganic salts capable of pH buffering. Either synthetic hydrotalcites or natural hydrotalcites can be used as the hydrotalcite compound in the present invention. Exemplary hydrotalcites that are useful in the compositions of the present are commercially available and include, but are not limited to, magnesium hydrotalcites such as DHT-4C (available from Kyowa Chemical Co.); Hysafe 539 and Hysafe 530 (available from J.M. Huber Corporation).

In a further aspect, suitable heat stabilizer additives include, for example, phosphonates such as dimethylbenzene phosphonate or the like, organic phosphates such as trimethyl phosphate, thioesters such as pentaerythritol betalaurylthiopropionate, and the like, or combinations comprising at least one of the foregoing heat stabilizers. Heat stabilizers are generally used in amounts of about 0.01 wt % to about 5 wt %, for example about 0.05 wt % to about 0.3 wt %, of the fiber reinforced thermoplastic resin composition.

In a further aspect, light stabilizers and/or ultraviolet light (UV) absorbing additives can also be used. Suitable light stabilizer additives include, for example, benzotriazoles such as 2-(2-hydroxy-5-methylphenyl)benzotriazole, 2-(2-hydroxy-5-tert-octylphenyl)-benzotriazole and benzophenones such as 2-hydroxy-4-n-octoxy benzophenone, or the like, or combinations comprising at least one of the foregoing light stabilizers. Light stabilizers are generally used in amounts of about 0.01 wt % to about 10 wt %, optionally about 0.1 wt % to about 1 wt %, of the composition.

In a further aspect, suitable UV absorbing additives include for example, hydroxybenzophenones; hydroxybenzotriazoles; hydroxybenzotriazines; cyanoacrylates; oxanilides; benzoxazinones; 2-(2H-benzotriazol-2-yl)-4-(1,1,3,3-tetramethylbutyl)-phenol (CYASORB™ 5411); 2-hydroxy-4-n-octyloxybenzophenone (CYASORB™ 531); 2-[4,6-bis(2,4-dimethylphenyl)-1,3,5-triazin-2-yl]-5-(octyloxy)-phenol (CYASORB™ 1164); 2,2′-(1,4-phenylene)bis(4H-3,1-benzoxazin-4-one) (CYASORB™ UV-3638); 1,3-bis[(2-cyano-3,3-diphenylacryloyl)oxy]-2,2-bis[[(2-cyano-3,3-diphenyl-acryloyl)oxy]methyl]propane (UVINUL™ 3030); 2,2′-(1,4-phenylene)bis(4H-3,1-benzoxazin-4-one); 1,3-bis[(2-cyano-3,3-diphenylacryloyl)oxy]-2,2-bis[[(2-cyano-3,3-diphenyl-acryloyl)oxy]methyl]propane; nano-size inorganic materials such as titanium oxide, cerium oxide, and zinc oxide, all with particle size less than about 100 nanometers; or the like, or combinations comprising at least one of the foregoing UV absorbers. UV absorbers are generally used in amounts of about 0.1 wt % to about 5 wt %, of the fiber reinforced thermoplastic resin composition.

In various aspects, plasticizers, lubricants, and/or mold release agents additives can also be used. There is a considerable overlap among these types of materials, which include, for example, di- or polyfunctional aromatic phosphates such as resorcinol tetraphenyl diphosphate (RDP), the bis(diphenyl)phosphate of hydroquinone and the bis(diphenyl)phosphate of bisphenol-A; poly-alpha-olefins; epoxidized soybean oil; silicones, including silicone oils; esters, for example, fatty acid esters such as medium and high molecular weight alkyl stearyl esters; mixtures of fatty acid esters and hydrophilic and hydrophobic nonionic surfactants comprising polyethylene glycol polymers, polypropylene glycol polymers, and copolymers thereof; waxes such as beeswax, montan wax, paraffin wax or the like. Such materials are generally used in amounts of about 0.1 wt % to about 20 wt %, optionally about 1 wt % to about 10 wt %, of the fiber reinforced thermoplastic resin composition.

In a further aspect, colorants such as pigment and/or dye additives can also be present. Suitable pigments include for example, inorganic pigments such as metal oxides and mixed metal oxides such as zinc oxide, titanium dioxides, iron oxides or the like; sulfides such as zinc sulfides, or the like; aluminates; sodium sulfo-silicates sulfates, chromates, or the like; carbon blacks; zinc ferrites; ultramarine blue; Pigment Brown 24; Pigment Red 101; Pigment Yellow 119; organic pigments such as azos, di-azos, quinacridones, perylenes, naphthalene tetracarboxylic acids, flavanthrones, isoindolinones, tetrachloroisoindolinones, anthraquinones, anthanthrones, dioxazines, phthalocyanines, and azo lakes; Pigment Blue 60, Pigment Red 122, Pigment Red 149, Pigment Red 177, Pigment Red 179, Pigment Red 202, Pigment Violet 29, Pigment Blue 15, Pigment Green 7, Pigment Yellow 147 and Pigment Yellow 150, or combinations comprising at least one of the foregoing pigments. Pigments are generally used in amounts of about 0.01 wt % to about 10 wt %, of the fiber reinforced thermoplastic resin composition.

In a further aspect, suitable dyes are generally organic materials and include, for example, coumarin dyes such as coumarin 460 (blue), coumarin 6 (green), nile red or the like; lanthanide complexes; hydrocarbon and substituted hydrocarbon dyes; polycyclic aromatic hydrocarbon dyes; scintillation dyes such as oxazole or oxadiazole dyes; aryl- or heteroaryl-substituted poly (C₂₋₈) olefin dyes; carbocyanine dyes; indanthrone dyes; phthalocyanine dyes; oxazine dyes; carbostyryl dyes; napthalenetetracarboxylic acid dyes; porphyrin dyes; bis(styryl)biphenyl dyes; acridine dyes; anthraquinone dyes; cyanine dyes; methine dyes; arylmethane dyes; azo dyes; indigoid dyes, thioindigoid dyes, diazonium dyes; nitro dyes; quinone imine dyes; aminoketone dyes; tetrazolium dyes; thiazole dyes; perylene dyes, perinone dyes; bis-benzoxazolylthiophene (BBOT); triarylmethane dyes; xanthene dyes; thioxanthene dyes; naphthalimide dyes; lactone dyes; fluorophores such as anti-stokes shift dyes which absorb in the near infrared wavelength and emit in the visible wavelength, or the like; luminescent dyes such as 7-amino-4-methylcoumarin; 3-(2′-benzothiazolyl)-7-diethylaminocoumarin; 2-(4-biphenylyl)-5-(4-t-butylphenyl)-1,3,4-oxadiazole; 2,5-bis-(4-biphenylyl)-oxazole; 2,2′-dimethyl-p-quaterphenyl; 2,2-dimethyl-p-terphenyl; 3,5,3″,5″-tetra-t-butyl-p-quinquephenyl; 2,5-diphenylfuran; 2,5-diphenyloxazole; 4,4′-diphenylstilbene; 4-dicyanomethylene-2-methyl-6-(p-dimethylaminostyryl)-4H-pyran; 1,1′-diethyl-2,2′-carbocyanine iodide; 3,3′-diethyl-4,4′,5,5′-dibenzothiatricarbocyanine iodide; 7-dimethylamino-1-methyl-4-methoxy-8-azaquinolone-2; 7-dimethylamino-4-methylquinolone-2; 2-(4-(4-dimethylaminophenyl)-1,3-butadienyl)-3-ethylbenzothiazolium perchlorate; 3-diethylamino-7-diethyliminophenoxazonium perchlorate; 2-(1-naphthyl)-5-phenyloxazole; 2,2′-p-phenylen-bis(5-phenyloxazole); rhodamine 700; rhodamine 800; pyrene; chrysene; rubrene; coronene, or the like, or amounts of about 0.1 to about 10 ppm.

In a further aspect, the anti-drip agents can also be present. Exemplary anti-drip agents can include a fibril forming or non-fibril forming fluoropolymer such as polytetrafluoroethylene (PTFE). The anti-drip agent can optionally be encapsulated by a rigid copolymer, for example styrene-acrylonitrile (SAN). PTFE encapsulated in SAN is known as TSAN. Encapsulated fluoropolymers can be made by polymerizing the encapsulating polymer in the presence of the fluoropolymer, for example, in an aqueous dispersion. TSAN can provide significant advantages over PTFE, in that TSAN can be more readily dispersed in the composition. A suitable TSAN can comprise, for example, about 50 wt % PTFE and about 50 wt % SAN, based on the total weight of the encapsulated fluoropolymer. Alternatively, the fluoropolymer can be pre-blended in some manner with a second polymer, such as for, example, an aromatic polycarbonate resin or SAN to form an agglomerated material for use as an anti-drip agent. Either method can be used to produce an encapsulated fluoropolymer.

In various aspects, the fiber reinforced thermoplastic resin compositions of the present invention further comprise an additive selected from coupling agents, antioxidants, mold release agents, UV absorbers, light stabilizers, heat stabilizers, lubricants, plasticizers, pigments, dyes, colorants, anti-static agents, nucleating agents, anti-drip agents, acid scavengers, and combinations of two or more of the foregoing. In a further aspect, the fiber reinforced thermoplastic resin compositions of the present invention further comprise at least one polymer additive selected from a flame retardant, a colorant, a primary anti-oxidant, and a secondary anti-oxidant.

In a further aspect, the fiber reinforced thermoplastic resin compositions further comprise a flame retardant selected from a chlorine-containing hydrocarbon, a bromine-containing hydrocarbon, boron compound, a metal oxide, antimony oxide, aluminum hydroxide, a molybdenum compound, zinc oxide, magnesium oxide, an organic phosphate, phospinate, phosphonate, phosphene, halogenated phosphorus compound, inorganic phosphorus containing salt, and a nitrogen-containing compound, or a combination comprising at least one of the foregoing. In a still further aspect, the flame retardant is a phosphorus-containing flame retardant. In a yet further aspect, the phosphorus-containing flame retardant is selected from resorcinol bis(biphenyl phosphate), bisphenol A bis(diphenyl phosphate), and hydroquinone bis(diphenyl phosphate), or mixtures thereof.

In a further aspect, the fiber reinforced thermoplastic resin compositions further comprise a primary anti-oxidant selected from a hindered phenol and secondary aryl amine, or a combination thereof. In a still further aspect, the hindered phenol comprises one or more compounds selected from triethylene glycol bis[3-(3-t-butyl-5-methyl-4-hydroxyphenyl)propionate], 1,6-hexanediol bis[3-(3,5-di-t-butyl-4-hydroxyphenyl)propionate], 2,4-bis(n-octylthio)-6-(4-hydroxy-3,5-di-t-butylanilino)-1,3,5-triazine, pentaerythrityl tetrakis[3-(3,5-di-t-butyl-4-hydroxyphenyl)propionate], 2,2-thiodiethylene bis[3-(3,5-di-t-butyl-4-hydroxyphenyl)propionate], octadecyl 3-(3,5-di-t-butyl-4-hydroxyphenyl)propionate, N,N′-hexamethylene bis(3,5-di-t-butyl-4-hydroxy-hydrocinnamamide), tetrakis(methylene 3,5-di-tert-butyl-hydroxycinnamate)methane, and octadecyl 3,5-di-tert-butylhydroxyhydrocinnamate. In a yet further aspect, the hindered phenol comprises octadecyl-3-(3,5-di-t-butyl-4-hydroxyphenyl)-propionate. In an even further aspect, the hindered phenol is present in an amount from about 0.01 wt % to about 0.50 wt %. In a still further aspect, the hindered phenol is present in an amount from about 0.01 wt % to about 0.20 wt %.

In a further aspect, the fiber reinforced thermoplastic resin compositions further comprise a secondary anti-oxidant selected from an organophosphate and thioester, or a combination thereof. In a yet further aspect, the secondary anti-oxidant is present in an amount from about 0.01 wt % to about 0.50 wt %, based on the total composition. In a still further aspect, the secondary anti-oxidant is present in an amount from about 0.01 wt % to about 0.20 wt %, based on the total composition.

In a further aspect, the fiber reinforced thermoplastic resin compositions further comprise an anti-drip agent. In a still further aspect, the anti-drip agent is a styrene-acrylonitrile copolymer encapsulated PTFE (TSAN). In a yet further aspect, the anti-drip agent is present in an amount from about 0.1 wt % to about 5 wt %, based on the total composition. In an even further aspect, the anti-drip agent is present in an amount from about 0.1 wt % to about 1 wt %, based on the total composition.

6. Manufacture of Fiber Reinforced Thermoplastic Compositions

In various aspects, the fiber reinforced thermoplastic resin compositions of the present invention can be manufactured by various methods. The compositions of the present invention can be blended with the aforementioned ingredients by a variety of methods involving intimate admixing of the materials with any additional additives desired in the formulation. Because of the availability of melt blending equipment in commercial polymer processing facilities, melt processing methods can be used. In various further aspects, the equipment used in such melt processing methods includes, but is not limited to, the following: co-rotating and counter-rotating extruders, single screw extruders, co-kneaders, disc-pack processors and various other types of extrusion equipment. In a further aspect, the extruder is a twin-screw extruder. In various further aspects, the melt processed composition exits processing equipment such as an extruder through small exit holes in a die. The resulting strands of molten resin are cooled by passing the strands through a water bath. The cooled strands can be chopped into small pellets for packaging and further handling.

The temperature of the melt is minimized in order to avoid excessive degradation of the resins. For example, it can be desirable to maintain the melt temperature between about 230° C. and about 350° C. in the molten resin composition, although higher temperatures can be used provided that the residence time of the resin in the processing equipment is kept short. In a still further aspect, the extruder is typically operated at a temperature of about 180° C. to about 385° C. In a yet further aspect, the extruder is typically operated at a temperature of about 200° C. to about 330° C. In an even further aspect, the extruder is typically operated at a temperature of about 220° C. to about 300° C.

In various aspects, the fiber reinforced thermoplastic resin compositions of the present invention can be prepared by blending the poly carbonate or polyalkylene terephthalate component or a combination thereof, the maleic anhydride additive component, reinforcement fiber component, and optional filler components in mixer, e.g. a HENSCHEL-Mixer® high speed mixer or other suitable mixer/blender. Other low shear processes, including but not limited to hand mixing, can also accomplish this blending. The mixture can then be fed into the throat of a twin-screw extruder via a hopper. Alternatively, at least one of the components can be incorporated into the composition by feeding directly into the extruder at the throat and/or downstream through a sidestuffer. Additives can also be compounded into a masterbatch desired polymeric resin and fed into the extruder. The extruder generally operated at a temperature higher than that necessary to cause the composition to flow. The extrudate is immediately quenched in a water bath and pelletized. The pellets, so prepared, when cutting the extrudate can be one-fourth inch long or less as desired. Such pellets can be used for subsequent molding, shaping, or forming.

In one aspect, the invention relates to a method for forming a thermoplastic blend comprising: a) combining: i) a thermoplastic polymer component comprising a polycarbonate, or polyalkylene terephthalate, or a combination thereof; ii) a reinforcement fiber component; and iii) a maleic anhydride additive component.

In further aspects, the invention relates to a method for forming a thermoplastic blend comprising: a) combining: i) a thermoplastic polymer component comprising a polycarbonate, or polyalkylene terephthalate, or a combination thereof; ii) a reinforcement fiber component; and iii) a maleic anhydride additive component; and b) extruding the thermoplastic blend. In further aspects, the step of combining comprises extrusion blending. In still further aspects, the method further comprises step of molding the thermoplastic polymer blend composition into a molded article.

In some aspects, the reinforcement fiber component comprises carbon fibers. In other aspects, the maleic anhydride component comprises maleic anhydride grafted polypropylene.

In further aspects, the invention pertains to methods of forming fiber reinforced thermoplastic resin compositions, wherein at room temperature, a molded part formed from the thermoplastic composition exhibits a greater tensile modulus compared to a molded part formed from a substantially identical reference composition comprising the same thermoplastic component and the same weight percentage of the same reinforcement fiber component, but in the absence of the maleic anhydride additive component.

In further aspects, the invention pertains to methods of forming fiber reinforced thermoplastic resin compositions, wherein, at 110° C., a molded part formed from the thermoplastic composition exhibits a greater tensile modulus compared to a molded part formed from a substantially identical reference composition comprising the same thermoplastic component and the same weight percentage of the same reinforcement fiber component, but in the absence of the maleic anhydride additive component.

In further aspects, the invention pertains to methods of forming fiber reinforced thermoplastic resin compositions, wherein, at 140° C., a molded part formed from the thermoplastic composition exhibits a greater tensile modulus compared to a molded part formed from a substantially identical reference composition comprising the same thermoplastic component and the same weight percentage of the same reinforcement fiber component, but in the absence of the maleic anhydride additive component.

In further aspects, the invention pertains to methods of forming fiber reinforced thermoplastic resin compositions, wherein at room temperature, a molded part formed from the thermoplastic composition exhibits a greater flexural modulus compared to a molded part formed from a substantially identical reference composition comprising the same thermoplastic component and the same weight percentage of the same reinforcement fiber component, but in the absence of the maleic anhydride additive component.

In further aspects, the invention pertains to methods of forming fiber reinforced thermoplastic resin compositions, wherein at room temperature, a molded part formed from the thermoplastic composition exhibits a greater tensile strength compared to a molded part formed from a substantially identical reference composition comprising the same thermoplastic component and the same weight percentage of the same reinforcement fiber component, but in the absence of the maleic anhydride additive component.

In further aspects, the invention pertains to methods of forming fiber reinforced thermoplastic resin compositions, wherein, at 110° C., a molded part formed from the thermoplastic composition exhibits a greater tensile strength compared to a molded part formed from a substantially identical reference composition comprising the same thermoplastic component and the same weight percentage of the same reinforcement fiber component, but in the absence of the maleic anhydride additive component.

In further aspects, the invention pertains to methods of forming fiber reinforced thermoplastic resin compositions, wherein, at 140° C., a molded part formed from the thermoplastic composition exhibits a greater tensile strength compared to a molded part formed from a substantially identical reference composition comprising the same thermoplastic component and the same weight percentage of the same reinforcement fiber component, but in the absence of the maleic anhydride additive component.

In further aspects, the invention pertains to methods of forming fiber reinforced thermoplastic resin compositions, wherein, at room temperature, a molded part formed from the thermoplastic composition exhibits a greater flexural strength compared to a molded part formed from a substantially identical reference composition comprising the same thermoplastic component and the same weight percentage of the same reinforcement fiber component, but in the absence of the maleic anhydride additive component.

In further aspects, the invention pertains to methods of forming fiber reinforced thermoplastic resin compositions, wherein, at room temperature, a molded part formed from the thermoplastic composition exhibits a greater notched Izod impact strength compared to a molded part formed from a substantially identical reference composition comprising the same thermoplastic component and the same weight percentage of the same reinforcement fiber component, but in the absence of the maleic anhydride additive component.

In one aspect, the invention pertains to methods of improving tensile modulus of a fiber reinforced thermoplastic resin compositions comprising the step of combining: i) a thermoplastic polymer component comprising a polycarbonate, or polyalkylene terephthalate, or a combination thereof; ii) a reinforcement fiber component; and iii) a maleic anhydride additive component.

In one aspect, the invention pertains to methods of improving flexural modulus of a fiber reinforced thermoplastic resin compositions comprising the step of combining: i) a thermoplastic polymer component comprising a polycarbonate, or polyalkylene terephthalate, or a combination thereof; ii) a reinforcement fiber component; and iii) a maleic anhydride additive component.

In one aspect, the invention pertains to methods of improving tensile strength of a fiber reinforced thermoplastic resin compositions comprising the step of combining: i) a thermoplastic polymer component comprising a polycarbonate, or polyalkylene terephthalate, or a combination thereof; ii) a reinforcement fiber component; and iii) a maleic anhydride additive component.

In one aspect, the invention pertains to methods of improving flexural strength of a fiber reinforced thermoplastic resin compositions comprising the step of combining: i) a thermoplastic polymer component comprising a polycarbonate, or polyalkylene terephthalate, or a combination thereof; ii) a reinforcement fiber component; and iii) a maleic anhydride additive component.

In one aspect, the invention pertains to methods of improving impact strength of a fiber reinforced thermoplastic resin compositions comprising the step of combining: i) a thermoplastic polymer component comprising a polycarbonate, or a polyalkylene terephthalate, or a combination thereof; ii) a reinforcement fiber component; and iii) a maleic anhydride additive component.

7. Fiber Reinforced Thermoplastic Resin Composition Properties

As noted above, the disclosed compositions exhibit good high temperature, as well as room temperature mechanical performance. In various aspects, the present invention can help overcome the stiffness (modulus) and strength issues of fiber reinforced thermoplastic compounds, at high temperatures.

In at least one aspect, the fiber reinforced thermoplastic resin composition exhibits exhibits improved tensile modulus. For example, in further aspects, at room temperature, a molded part formed from the thermoplastic composition exhibits a greater tensile modulus compared to a molded part formed from a substantially identical reference composition comprising the same thermoplastic component and the same weight percentage of the same reinforcement fiber component, but in the absence of the maleic anhydride additive component.

In another aspect, at 110° C., a molded part formed from the fiber reinforced thermoplastic composition exhibits a greater tensile modulus compared to a molded part formed from a substantially identical reference composition comprising the same thermoplastic component and the same weight percentage of the same reinforcement fiber component, but in the absence of the maleic anhydride additive component.

In another aspect, at 140° C., a molded part formed from the fiber reinforced thermoplastic composition exhibits a greater tensile modulus compared to a molded part formed from a substantially identical reference composition comprising the same thermoplastic component and the same weight percentage of the same reinforcement fiber component, but in the absence of the maleic anhydride additive component.

In at least one aspect, the fiber reinforced thermoplastic resin composition exhibits exhibits improved flexural modulus at room temperature. For example, in further aspects, at room temperature, a molded part formed from the thermoplastic composition exhibits a greater flexural modulus compared to a molded part formed from a substantially identical reference composition comprising the same thermoplastic component and the same weight percentage of the same reinforcement fiber component, but in the absence of the maleic anhydride additive component.

In at least one aspect, the fiber reinforced thermoplastic resin composition exhibits exhibits improved tensile strength at room temperature. For example, in further aspects, at room temperature, a molded part formed from the thermoplastic composition exhibits a greater tensile strength compared to a molded part formed from a substantially identical reference composition comprising the same thermoplastic component and the same weight percentage of the same reinforcement fiber component, but in the absence of the maleic anhydride additive component.

In another aspect, at 110° C., a molded part formed from the fiber reinforced thermoplastic composition exhibits a greater tensile strength compared to a molded part formed from a substantially identical reference composition comprising the same thermoplastic component and the same weight percentage of the same reinforcement fiber component, but in the absence of the maleic anhydride additive component.

In another aspect, at 140° C., a molded part formed from the fiber reinforced thermoplastic composition exhibits a greater tensile strength compared to a molded part formed from a substantially identical reference composition comprising the same thermoplastic component and the same weight percentage of the same reinforcement fiber component, but in the absence of the maleic anhydride additive component.

In at least one aspect, the fiber reinforced thermoplastic resin composition exhibits exhibits improved flexural strength. For example, in further aspects, at room temperature, a molded part formed from the thermoplastic composition exhibits a greater flexural strength compared to a molded part formed from a substantially identical reference composition comprising the same thermoplastic component and the same weight percentage of the same reinforcement fiber component, but in the absence of the maleic anhydride additive component.

In at least one aspect, the fiber reinforced thermoplastic resin composition exhibits exhibits improved notched Izod impact strength. For example, in further aspects, at room temperature, a molded part formed from the thermoplastic composition exhibits a greater notched Izod impact strength compared to a molded part formed from a substantially identical reference composition comprising the same thermoplastic component and the same weight percentage of the same reinforcement fiber component, but in the absence of the maleic anhydride additive component.

### C. ARTICLES OF MANUFACTURE

In a further aspect, the fiber reinforced thermoplastic resin composition is capable of being used in the production of an article, wherein good high temperature, as well as room temperature mechanical performance are desirable. By overcoming the low impact and strength issues of prior art fiber reinforced thermoplastic compounds, including at room temperature, the fiber reinforced thermoplastic resin composition allows for the production of an article with mechanical properties suitable for use in automotive applications, such as, automotive interior or under-the-hood applications, in electronic devices, such as, hard disk drive disk separators, electronic connectors and the like.

In various aspects, the disclosed fiber reinforced thermoplastic resin compositions of the present invention can be used in making articles. The disclosed fiber reinforced thermoplastic resin compositions can be formed into useful shaped articles by a variety of means such as; injection molding, extrusion, rotational molding, compression molding, blow molding, sheet or film extrusion, profile extrusion, gas assist molding, structural foam molding and thermoforming. The fiber reinforced thermoplastic resin compositions described herein can also be made into film and/or sheet as well as components of laminate systems. In a further aspect, in an aspect, a method of manufacturing an article comprises melt blending the thermoplastic polymer components, and reinforcement fiber component; and any additive component; and molding the extruded composition into an article. In a still further aspect, the extruding is done with a twin-screw extruder.

Shaped, formed, or molded articles including the composites are also provided. The composites can be molded into useful shaped articles by a variety of means such as injection molding, extrusion, rotational molding, blow molding and thermoforming to form articles such as, for example, personal computers, notebook and portable computers, cell phone antennas and other such communications equipment, medical applications, RFID applications, automotive applications, and the like. In various further aspects, formed articles include, but are not limited to, electronic devices, medical devices, electrical connectors, enclosures for electrical equipment, protective carrying cases for electronic equipment, electric motor parts, power distribution equipment, communication equipment, computers, and the like.

In a further aspect, the method comprises forming a molded part from the formed fiber reinforced thermoplastic resin composition.

### D. ASPECTS

In various aspects, the present invention pertains to and includes at least the following aspects.

Aspect 1: A fiber reinforced thermoplastic composition comprising: a) a thermoplastic polymer component comprising a polycarbonate, or polyalkylene terephthalate, or a combination thereof; b) a reinforcement fiber component; and c) a maleic anhydride additive component.

Aspect 2: The fiber reinforced thermoplastic composition of aspect 1, comprising: a) from about 30 wt. % to less than 100 wt. % of a thermoplastic polymer component comprising a polycarbonate, or polyalkylene terephthalate, or a combination thereof; b) from greater than 0 wt. % to about 70 wt. % of a reinforcement filler component; and c) from greater than 0 wt. % to about 10 wt. % of a maleic anhydride additive component.

Aspect 3: The fiber reinforced thermoplastic composition of any preceding aspect, wherein the thermoplastic polymer component is present in an amount in the range of from 50 to 95 weight percent relative to the total weight of the composition.

Aspect 4: The fiber reinforced thermoplastic composition of any preceding aspect, wherein the thermoplastic polymer is present in an amount in the range of from 60 to 90 weight percent relative to the total weight of the composition.

Aspect 5: The fiber reinforced thermoplastic composition of any preceding aspect, wherein the thermoplastic polymer component comprises polycarbonate, is present in an amount in the range of from 50 to 95 weight percent relative to the total weight of the composition.

Aspect 6: The fiber reinforced thermoplastic composition of any preceding aspect, wherein the reinforcement fiber component is present in the composition in an amount in the range of from 5 to 50 weight percent relative to the total weight of the composition.

Aspect 7: The fiber reinforced thermoplastic composition of any preceding aspect, wherein the reinforcement fiber component is present in the composition in an amount in the range of from 10 to 40 weight percent relative to the total weight of the composition.

Aspect 8: The fiber reinforced thermoplastic composition of any preceding aspect, wherein the reinforcement fiber component comprises carbon fibers.

Aspect 9: The fiber reinforced thermoplastic composition of any preceding aspect, wherein the reinforcement fiber component comprises carbon fibers having a tensile modulus in the range of from 28 to 48 MSI.

Aspect 10: The fiber reinforced thermoplastic composition of any preceding aspect, wherein the reinforcement fiber component comprises carbon fibers having a tensile modulus in the range of from 32 to 45 MSI.

Aspect 11: The fiber reinforced thermoplastic composition of any preceding aspect, wherein the reinforcement fiber component comprises carbon fibers having a tensile modulus in the range of from 35 to 42 MSI.

Aspect 12: The fiber reinforced thermoplastic composition of any preceding aspect, wherein the reinforcement fiber component comprises carbon fibers having a tensile strength in the range of from 400 to 1200 KSI.

Aspect 13: The fiber reinforced thermoplastic composition of any preceding aspect, wherein the reinforcement fiber component comprises carbon fibers having a tensile strength in the range of from 500 to 1000 KSI.

Aspect 14: The fiber reinforced thermoplastic composition of any preceding aspect, wherein the reinforcement fiber component comprises carbon fibers having a tensile strength in the range of from 700 to 900 KSI.

Aspect 15: The fiber reinforced thermoplastic composition of any preceding aspect wherein the maleic anhydride component is present in an amount in the range of from 1 to 6 weight percent relative to the total weight of the composition.

Aspect 16: The fiber reinforced thermoplastic composition of any preceding aspect, wherein the maleic anhydride component is present in an amount in the range of from 2 to 4 weight percent relative to the total weight of the composition.

Aspect 17: The fiber reinforced thermoplastic composition of any preceding aspect, wherein the maleic anhydride component comprises maleic anhydride grafted polymer.

Aspect 18: The fiber reinforced thermoplastic composition of any preceding aspect, wherein the maleic anhydride component comprises maleic anhydride grafted polypropylene.

Aspect 19: The fiber reinforced thermoplastic composition of any preceding aspect, wherein the thermoplastic polymer component comprises polycarbonate (PC), polybutylene terephthalate (PBT), or polycarbonate-polybutylene terephthalate (PC/PBT) blend.

Aspect 20: The fiber reinforced thermoplastic composition of aspect 19, wherein the thermoplastic polymer component comprises a polycarbonate.

Aspect 21: The fiber reinforced thermoplastic composition of aspect 19, wherein the thermoplastic polymer component comprises polybutylene terephthalate.

Aspect 22: The fiber reinforced thermoplastic composition of aspect 19, wherein the thermoplastic polymer component comprises a polycarbonate-polybutylene terephthalate (PC/PBT) blend.

Aspect 23: The fiber reinforced thermoplastic composition of any preceding aspect, wherein at room temperature, a molded part formed from the thermoplastic composition exhibits a greater tensile modulus compared to a molded part formed from a substantially identical reference composition comprising the same thermoplastic component and the same weight percentage of the same reinforcement fiber component, but in the absence of the maleic anhydride additive component.

Aspect 24: The fiber reinforced thermoplastic composition of any preceding aspect, wherein at room temperature, a molded part formed from the thermoplastic composition exhibits a greater flexural modulus compared to a molded part formed from a substantially identical reference composition comprising the same thermoplastic component and the same weight percentage of the same reinforcement fiber component, but in the absence of the maleic anhydride additive component.

Aspect 25: The fiber reinforced thermoplastic composition according to any preceding aspect, wherein at room temperature, a molded part formed from the thermoplastic composition exhibits a greater tensile strength compared to a molded part formed from a substantially identical reference composition comprising the same thermoplastic component and the same weight percentage of the same reinforcement fiber component, but in the absence of the maleic anhydride additive component.

Aspect 26: The fiber reinforced thermoplastic composition according to any preceding aspect, wherein at room temperature, a molded part formed from the thermoplastic composition exhibits a greater flexural strength compared to a molded part formed from a substantially identical reference composition comprising the same thermoplastic component and the same weight percentage of the same reinforcement fiber component, but in the absence of the maleic anhydride additive component.

Aspect 27: The fiber reinforced thermoplastic composition according aspect 21 or 22, wherein at room temperature, a molded part formed from the thermoplastic composition exhibits a greater notched Izod impact strength compared to a molded part formed from a substantially identical reference composition comprising the same thermoplastic component and the same weight percentage of the same reinforcement fiber component, but in the absence of the maleic anhydride additive component.

Aspect 28: The fiber reinforced thermoplastic composition of any preceding aspect, wherein at 110° C., a molded part formed from the thermoplastic composition exhibits a greater tensile modulus compared to a molded part formed from a substantially identical reference composition comprising the same thermoplastic component and the same weight percentage of the same reinforcement fiber component, but in the absence of the maleic anhydride additive component.

Aspect 29: The fiber reinforced thermoplastic composition of any preceding aspect, wherein at 110° C., a molded part formed from the thermoplastic composition exhibits a greater tensile strength compared to a molded part formed from a substantially identical reference composition comprising the same thermoplastic component and the same weight percentage of the same reinforcement fiber component, but in the absence of the maleic anhydride additive component.

Aspect 30: The fiber reinforced thermoplastic composition of any preceding aspect, wherein at 140° C., a molded part formed from the thermoplastic composition exhibits a greater tensile modulus compared to a molded part formed from a substantially identical reference composition comprising the same thermoplastic component and the same weight percentage of the same reinforcement fiber component, but in the absence of the maleic anhydride additive component.

Aspect 31: The fiber reinforced thermoplastic composition of any preceding aspect, wherein at 140° C., a molded part formed from the thermoplastic composition exhibits a greater tensile strength compared to a molded part formed from a substantially identical reference composition comprising the same thermoplastic component and the same weight percentage of the same reinforcement fiber component, but in the absence of the maleic anhydride additive component.

Aspect 32: A fiber reinforced thermoplastic composition, comprising: a) from about 60 wt. % to about 90 wt. % of a thermoplastic polymer component comprising a polycarbonate (PC), polybutylene terephthalate (PBT), or polycarbonate-polybutylene terephthalate (PC/PBT) blend; b) from greater than 10 wt. % to about 30 wt. % of a reinforcement filler component; and c) from greater than 0 wt. % to about 6 wt. % of a maleic anhydride additive component comprising maleic anhydride grafted polypropylene.

Aspect 33: The fiber reinforced thermoplastic composition of aspect 32, wherein the reinforcement fiber component comprises carbon fibers having a tensile modulus in the range of from 28 to 48 MSI.

Aspect 34: The fiber reinforced thermoplastic composition of aspect 32 or 33, wherein the maleic anhydride component comprises maleic anhydride grafted polypropylene.

Aspect 35: The fiber reinforced thermoplastic composition of any of aspects 32-34, wherein the thermoplastic polymer component comprises a polycarbonate (PC).

Aspect 36: The fiber reinforced thermoplastic composition of any of aspects 32-34, wherein the thermoplastic polymer component comprises polybutylene terephthalate (PBT).

Aspect 37: The fiber reinforced thermoplastic composition of any of aspects 32-34, wherein the thermoplastic polymer component comprises a polycarbonate-polybutylene terephthalate (PC/PBT) blend.

Aspect 38: The fiber reinforced thermoplastic composition of any of aspects 32-37, wherein at room temperature, a molded part formed from the thermoplastic composition exhibits a greater tensile modulus compared to a molded part formed from a substantially identical reference composition comprising the same thermoplastic component and the same weight percentage of the same reinforcement fiber component, but in the absence of the maleic anhydride additive component.

Aspect 39: The fiber reinforced thermoplastic composition of any of aspects 32-37, wherein at room temperature, a molded part formed from the thermoplastic composition exhibits a greater flexural modulus compared to a molded part formed from a substantially identical reference composition comprising the same thermoplastic component and the same weight percentage of the same reinforcement fiber component, but in the absence of the maleic anhydride additive component.

Aspect 40: The fiber reinforced thermoplastic composition of any of aspects 32-37, wherein at room temperature, a molded part formed from the thermoplastic composition exhibits a greater tensile strength compared to a molded part formed from a substantially identical reference composition comprising the same thermoplastic component and the same weight percentage of the same reinforcement fiber component, but in the absence of the maleic anhydride additive component.

Aspect 41: The fiber reinforced thermoplastic composition any of aspects 32-37, wherein at room temperature, a molded part formed from the thermoplastic composition exhibits a greater flexural strength compared to a molded part formed from a substantially identical reference composition comprising the same thermoplastic component and the same weight percentage of the same reinforcement fiber component, but in the absence of the maleic anhydride additive component.

Aspect 42: The fiber reinforced thermoplastic composition of aspect 36 or 37, wherein at room temperature, a molded part formed from the thermoplastic composition exhibits a greater notched Izod impact strength compared to a molded part formed from a substantially identical reference composition comprising the same thermoplastic component and the same weight percentage of the same reinforcement fiber component, but in the absence of the maleic anhydride additive component.

Aspect 43: An article of manufacture comprising the fiber reinforced thermoplastic composition according to any of the preceding aspects.

Aspect 44: A method for forming a thermoplastic blend comprising: combining: i) a thermoplastic polymer component comprising a polycarbonate, or polyalkylene terephthalate, or a combination thereof; ii) a reinforcement fiber component; and iii) a maleic anhydride additive component.

Aspect 45: The method according to aspect 44, wherein the step of combining comprises extrusion blending.

Aspect 46: The method according to aspect 44 or 45, further comprising step of molding the thermoplastic polymer blend composition into a molded article.

Aspect 47: The method of according to any of aspects 44-46, wherein the reinforcement fiber component comprises carbon fibers.

Aspect 48: The method according to any of aspects 44-47, wherein the thermoplastic polymer component comprises a polycarbonate.

Aspect 49: The method according to any of aspects 44-47, wherein the thermoplastic polymer component comprises polybutylene terephthalate.

Aspect 50: The method according to any of aspects 44-47, wherein the thermoplastic polymer component comprises a polycarbonate-polybutylene terephthalate (PC/PBT) blend.

Aspect 51: The method according to any of aspects 44-50, wherein the maleic anhydride component comprises maleic anhydride grafted polypropylene.

Aspect 52: The method according to any of aspects 44-51, wherein at room temperature, a molded part formed from the thermoplastic composition exhibits a greater tensile modulus compared to a molded part formed from a substantially identical reference composition comprising the same thermoplastic component and the same weight percentage of the same reinforcement fiber component, but in the absence of the maleic anhydride additive component.

Aspect 53: The method according to any of aspects 44-51, wherein at room temperature, a molded part formed from the thermoplastic composition exhibits a greater flexural modulus compared to a molded part formed from a substantially identical reference composition comprising the same thermoplastic component and the same weight percentage of the same reinforcement fiber component, but in the absence of the maleic anhydride additive component.

Aspect 54: The method according to any of aspects 44-51, wherein at room temperature, a molded part formed from the thermoplastic composition exhibits a greater tensile strength compared to a molded part formed from a substantially identical reference composition comprising the same thermoplastic component and the same weight percentage of the same reinforcement fiber component, but in the absence of the maleic anhydride additive component.

Aspect 55: The method according to any of aspects 44-51, wherein at room temperature, a molded part formed from the thermoplastic composition exhibits a greater flexural strength compared to a molded part formed from a substantially identical reference composition comprising the same thermoplastic component and the same weight percentage of the same reinforcement fiber component, but in the absence of the maleic anhydride additive component.

Aspect 56: The method according to aspect 49 or 50, wherein at room temperature, a molded part formed from the thermoplastic composition exhibits a greater notched Izod impact strength compared to a molded part formed from a substantially identical reference composition comprising the same thermoplastic component and the same weight percentage of the same reinforcement fiber component, but in the absence of the maleic anhydride additive component.

Without further elaboration, it is believed that one skilled in the art can, using the description herein, utilize the present invention. The following examples are included to provide addition guidance to those skilled in the art of practicing the claimed invention. The examples provided are merely representative of the work and contribute to the teaching of the present invention. Accordingly, these examples are not intended to limit the invention in any manner.

While aspects of the present invention can be described and claimed in a particular statutory class, such as the system statutory class, this is for convenience only and one of skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way Appreciably intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

Throughout this application, various publications are referenced. The disclosures of these publications in their entireties are hereby incorporated by reference into this application in order to more fully describe the state of the art to which this pertains. The references disclosed are also individually and specifically incorporated by reference herein for the material contained in them that is discussed in the sentence in which the reference is relied upon. Nothing herein is to be construed as an admission that the present invention is not entitled to antedate such publication by virtue of prior invention. Further, the dates of publication provided herein can be different from the actual publication dates, which can require independent confirmation.

### E. EXAMPLES

The following examples are put forth so as to provide those of ordinary skill in the art with a complete disclosure and description of how the compounds, compositions, articles, devices and/or methods claimed herein are made and evaluated, and are intended to be purely exemplary and are not intended to limit the disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric. Unless indicated otherwise, percentages referring to composition are in terms of wt %.

There are numerous variations and combinations of reaction conditions, e.g., component concentrations, desired solvents, solvent mixtures, temperatures, pressures and other reaction ranges and conditions that can be used to optimize the product purity and yield obtained from the described process. Only reasonable and routine experimentation will be required to optimize such process conditions.

The materials shown in Table 1 were used to prepare the compositions described and evaluated herein.

TABLE 1

| Item | Description | Supplier |
|---|---|---|
| PC | BPA polycarbonate resin made by an | SABIC IP |
| | interfacial process with MVR at 300° C./ | |
| | 1.2 kg, of about 10 cc/10 min.; | |
| | commercially available under the trade | |
| | name Lexan 144. | |
| PBT | Polybutylene terephthalate resin | SABIC IP |
| | commercially available under the trade | |
| | name Valox 305. | |
| PC/PBT | Polycarbonate (PC)/polybutylene | SABIC IP |
| | terephthalate (PBT) resin blend | |
| | commercially available under the trade | |
| | name Xenoy 1103. | |
| CF | Intermediate modulus carbon fiber | Hexcel Inc. |
| | having a tensile modulus of 40 MSI | |
| | and tensile strength of 822 KSI; and | |
| | initial chopped length of 6-9 mm. | |
| | Commercially available under the | |
| | trade name HexTow IM7. | |
| MAH-PP | Polypropylene random copolymer | DuPont Inc. |
| | highly grafted with maleic anhydride | |
| | having a density of 0.904 g/cm³ and | |
| | melting point of 135° C. Commercially | |
| | available under the trade name | |
| | Fusabond P353. | |

In each of the examples, sample batches (10 kg) were prepared by compounding the materials in a ZSK 40 mm twin screw extruder where the PC, PBT or PC/PBT resin blend and any additives were added at the feed throat and the carbon fibers were fed downstream. The barrel temperatures ranged from 245° C. to 290° C. The screw speed was 200 rpm and the feed rate was 100 lbs/hr. To make test specimens, the dried pellets were injection molded to form appropriate test samples with barrel temperatures of 270° C. to 290° C. and mold temperature set to 90° C. to 100° C.

The mechanical properties of the compounds were evaluated at 23° C. As one of skill in the art would appreciate, for the automotive under the hood application, materials may experience temperatures as high as 140° C. In a further aspects, for the automotive instrument panel applications, temperatures along the top of the instrument panel can reach as high as 110° C. Accordingly, additional tensile testing was performed at 110° C. and 140° C.

Notched Izod impact strength (‘NII’) was measured using an impact tester from Tinius Olsen and was carried out in accordance with ASTM D 256. This test fixes one end of a notched specimen in a cantilever position by means of a vice. A striker on the arm of a pendulum or similar energy carrier then strikes the specimen. The energy absorbed by the specimen in the breaking process can be converted into an indication of a materials notched impact resistance using such units as foot-pounds or joules.

Tensile modulus, tensile strength and tensile elongation were measured using a Material Testing System (MTS) from Instron with a test speed of 5 mm/min and carried out in accordance with ASTM D 638. Dog-bone shaped ASTM tensile bar specimens were clamped between the two grips of the Instron MTS and a continually increasing uniaxial load was applied on the test specimens and tensile properties were measured from the stress-strain curves generated during the testing.

Flexural modulus and flexural strength were determined by three-point bending test on ASTM flexural bar specimens with a test span of 50 mm and was carried out in accordance with ASTM D 790. Testing was performed on an Instron Material Testing System (MTS) with a 1.3 mm/min cross-head speed.

Table 2 below shows the compositions of different thermoplastic blend compositions described herein, including control compositions, labeled “COMP.”, and exemplary compositions of the present invention, labeled “EX.”, which have maleic anhydride grafted polypropylene incorporated as an additive in the formulation.

TABLE 2*

| No. | Item | COMP. 1 | EX. 2 | COMP. 3 | EX. 4 | COMP. 5 | EX. 6 |
|---|---|---|---|---|---|---|---|
| 1 | PC | 70 | 67 | | | | |
| 2 | PBT | | | 70 | 67 | | |
| 3 | PC/PBT | | | | | 70 | 67 |
| 4 | CF | 30 | 30 | 30 | 30 | 30 | 30 |
| 5 | MAH-PP | | 3 | | 3 | | 3 |

| | | | | | | |
|---|---|---|---|---|---|---|
| Formulation Total | 100 | 100 | 100 | 100 | 100 | 100 |

*Amounts provided in terms of percent of total composition (by weight).

Table 3 below shows the room temperature mechanical properties of 30 wt % carbon fiber (CF) reinforced PC, PBT, and PC/PBT blends with and without the maleic anhydride grafted polypropylene additive at 3 wt % loading.

TABLE 3

| No. | Test | Test Detail | Units | COMP. 1 | EX. 2 | COMP. 3 | EX. 4 | COMP. 5 | EX. 6 |
|---|---|---|---|---|---|---|---|---|---|
| 1 | FM | ASTM D 790 | MPa | 20400 | 23000 | 22400 | 23700 | 19300 | 21200 |
| 2 | FS | ASTM D 790 | MPa | 274 | 295 | 319 | 342 | 232 | 255 |
| 3 | TM | ASTM D 638 | MPa | 25460 | 27020 | 31440 | 32820 | 25840 | 26920 |
| 4 | TS | ASTM D 638 | MPa | 181 | 193 | 221 | 233 | 165 | 172 |
| 5 | TE | ASTM D 638 | % | 1.85 | 1.19 | 1.62 | 1.41 | 1.49 | 1.48 |
| 6 | NII | ASTM D 256 | J/m | 130 | 126 | 93.8 | 118 | 94.4 | 135 |

As the data shows, PC/CF formulations with MAH-PP exhibits both improved stiffness (tensile and flexural modulus), and strength (tensile and flexural) when compared to the comparative PC/CF formulation without MAH-PP.

Moreover, PBT/CF formulations with MAH-PP exhibited improved stiffness (tensile and flexural modulus), strength (tensile and flexural) and notched Izod impact strength when compared to the comparative PBT/CF formulation without MAH-PP.

Likewise, PC/PBT/CF formulations with MAH-PP also exhibited improved stiffness (tensile and flexural modulus), strength (tensile and flexural) and notched Izod impact strength when compared to the comparative PC/PBT/CF formulation without MAH-PP. Notably, the NII of the inventive PBT and PC/PBT formulations showed improvements of 26% and 43%, respectively.

Table 4 below shows the tensile properties of carbon fiber (CF) reinforced PC, PBT, and PBT/PC blends at 110° C. with and without the maleic anhydride additive component at 3 wt % loading.

TABLE 4

| No. | Test | Test Detail | Units | COMP. 1 | EX. 2 | COMP. 3 | EX. 4 | COMP. 5 | EX. 6 |
|---|---|---|---|---|---|---|---|---|---|
| 3 | TM | ASTM D 638 | MPa | 18038 | 20536 | 12660 | 13880 | 12880 | 14640 |
| 4 | TS | ASTM D 638 | MPa | 114 | 131 | 108 | 120 | 63 | 86 |
| 5 | TE | ASTM D 638 | % | 1.85 | 1.15 | 2.6 | 2.3 | 3.3 | 2.5 |

Table 5 below shows the tensile properties of carbon fiber (CF) reinforced PC, PBT, and PC/PBT blends at 140° C. with and without the maleic anhydride additive component at 3 wt % loading.

TABLE 5

| No. | Test | Test Detail | Units | COMP. 1 | EX. 2 | COMP. 3 | EX. 4 | COMP. 5 | EX. 6 |
|---|---|---|---|---|---|---|---|---|---|
| 3 | TM | ASTM D 638 | MPa | 17087 | 19541 | 11355 | 12960 | 4843 | 7973 |
| 4 | TS | ASTM D 638 | MPa | 67 | 84 | 89 | 97 | 29 | 40 |
| 5 | TE | ASTM D 638 | % | 1.09 | 1.03 | 3.1 | 2.7 | 5.4 | 4.0 |

As the data shows, at high temperatures, PC/CF formulations with MAH-PP exhibited both improved tensile modulus and tensile strength when compared to the comparative PC/CF formulation without MAH-PP.

Likewise, at high temperatures, PBT/CF formulations with MAH-PP exhibited both improved tensile modulus and tensile strength when compared to the comparative PBT/CF formulation without MAH-PP.

Similarly, at high temperatures, PC/PBT/CF formulations with MAH-PP exhibited both improved tensile modulus and tensile strength when compared to the comparative PC/PBT/CF formulation without MAH-PP

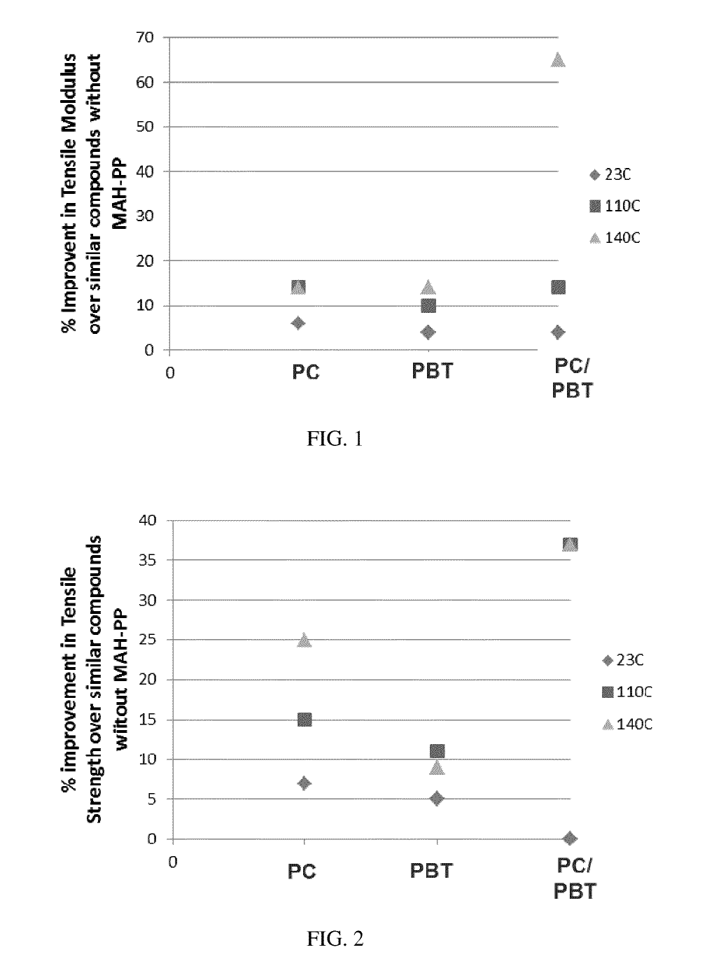

As represented in FIGS. 1 and 2, all inventive formulations showed improvement in mechanical performance at all the temperatures tested, the greater improvement seen in PC/PBT/CF formulations. The data suggests the addition of maleic anhydride grafted polypropylene improves the room temperature and high temperature mechanical performance of carbon fiber reinforced PC, PBT (polybutylene terephthalate) and PC/PBT blends.

The patentable scope of the invention is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A fiber reinforced thermoplastic composition comprising:
a) a thermoplastic polymer component comprising a combination of polycarbonate and polyalkylene terephthalate;
b) a reinforcement fiber component; and
c) a maleic anhydride additive component in the amount of from about 2% to about 10% of the weight of said fiber reinforced thermoplastic composition.

2. The fiber reinforced thermoplastic composition of claim 1, comprising
a) from about 30 weight % to less than 100 weight % of said fiber reinforced thermoplastic composition of a thermoplastic polymer component comprising a combination of polycarbonate and polyalkylene terephthalate;
b) from greater than 0 weight % to about 70 weight % of said fiber reinforced thermoplastic composition of a reinforcement filler component; and
c) from 2 weight % to about 10 weight % of said fiber reinforced thermoplastic composition of a maleic anhydride additive component.

3. The fiber reinforced thermoplastic composition of claim 1, wherein the thermoplastic polymer component is present in an amount in the range of from 50 to 95 weight percent relative to the total weight of the composition.

4. The fiber reinforced thermoplastic composition of claim 1, wherein the thermoplastic polymer is present in an amount in the range of from 60 to 90 weight percent relative to the total weight of the composition.

5. The fiber reinforced thermoplastic composition of claim 1, wherein the thermoplastic polymer component comprises polycarbonate, is present in an amount in the range of from 50 to 95 weight percent relative to the total weight of the composition.

6. The fiber reinforced thermoplastic composition of claim 1, wherein the reinforcement fiber component is present in the composition in an amount in the range of from 5 to 50 weight percent relative to the total weight of the composition.

7. The fiber reinforced thermoplastic composition of claim 1, wherein the reinforcement fiber component is present in the composition in an amount in the range of from 10 to 40 weight percent relative to the total weight of the composition.

8. The fiber reinforced thermoplastic composition of claim 1, wherein the reinforcement fiber component comprises carbon fibers.

9. The fiber reinforced thermoplastic composition of claim 1, wherein the reinforcement fiber component comprises carbon fibers having a tensile modulus in the range of from 28 to 48 MSI.

10. The fiber reinforced thermoplastic composition of claim 1, wherein the reinforcement fiber component comprises carbon fibers having a tensile modulus in the range of from 32 to 45 MSI.

11. The fiber reinforced thermoplastic composition of claim 1, wherein the reinforcement fiber component comprises carbon fibers having a tensile modulus in the range of from 35 to 42 MSI.

12. The fiber reinforced thermoplastic composition of claim 1, wherein the reinforcement fiber component comprises carbon fibers having a tensile strength in the range of from 400 to 1200 KSI.

13. The fiber reinforced thermoplastic composition of claim 1, wherein the reinforcement fiber component comprises carbon fibers having a tensile strength in the range of from 500 to 1000 KSI.

14. The fiber reinforced thermoplastic composition of claim 1, wherein the reinforcement fiber component comprises carbon fibers having a tensile strength in the range of from 700 to 900 KSI.

15. The fiber reinforced thermoplastic composition of claim 1, wherein the maleic anhydride component is present in an amount in the range of from 2 to 6 weight percent relative to the total weight of the composition.

16. The fiber reinforced thermoplastic composition of claim 1, wherein the maleic anhydride component is present in an amount in the range of from 2 to 4 weight percent relative to the total weight of the composition.

17. The fiber reinforced thermoplastic composition of claim 1, wherein the maleic anhydride component comprises maleic anhydride grafted polymer.

18. The fiber reinforced thermoplastic composition of claim 1, wherein the maleic anhydride component comprises maleic anhydride grafted polypropylene.

19. The fiber reinforced thermoplastic composition of claim 1, wherein the thermoplastic polymer component comprises polycarbonate-polybutylene terephthalate (PC/PBT) blend.

20. (canceled)

21. (canceled)

22. The fiber reinforced thermoplastic composition of claim 19, wherein the thermoplastic polymer component is a polycarbonate-polybutylene terephthalate (PC/PBT) blend.

23. The fiber reinforced thermoplastic composition of claim 1, wherein at room temperature, a molded part formed from the thermoplastic composition exhibits a greater tensile modulus compared to a molded part formed from a substantially identical reference composition comprising the same thermoplastic component and the same weight percentage of the same reinforcement fiber component, but in the absence of the maleic anhydride additive component.

24. The fiber reinforced thermoplastic composition of claim 1, wherein at room temperature, a molded part formed from the thermoplastic composition exhibits a greater flexural modulus compared to a molded part formed from a substantially identical reference composition comprising the same thermoplastic component and the same weight percentage of the same reinforcement fiber component, but in the absence of the maleic anhydride additive component.

25. The fiber reinforced thermoplastic composition of claim 1, wherein at room temperature, a molded part formed from the thermoplastic composition exhibits a greater tensile strength compared to a molded part formed from a substantially identical reference composition comprising the same thermoplastic component and the same weight percentage of the same reinforcement fiber component, but in the absence of the maleic anhydride additive component.

26. The fiber reinforced thermoplastic composition of claim 1, wherein at room temperature, a molded part formed from the thermoplastic composition exhibits a greater flexural strength compared to a molded part formed from a substantially identical reference composition comprising the same thermoplastic component and the same weight percentage of the same reinforcement fiber component, but in the absence of the maleic anhydride additive component.

27. The fiber reinforced thermoplastic composition of claim 1, wherein at room temperature, a molded part formed from the thermoplastic composition exhibits a greater notched Izod impact strength compared to a molded part formed from a substantially identical reference composition comprising the same thermoplastic component and the same weight percentage of the same reinforcement fiber component, but in the absence of the maleic anhydride additive component.

28. The fiber reinforced thermoplastic composition of claim 1, wherein at 110° C., a molded part formed from the thermoplastic composition exhibits a greater tensile modulus compared to a molded part formed from a substantially identical reference composition comprising the same thermoplastic component and the same weight percentage of the same reinforcement fiber component, but in the absence of the maleic anhydride additive component.

29. The fiber reinforced thermoplastic composition of claim 1, wherein at 110° C., a molded part formed from the thermoplastic composition exhibits a greater tensile strength compared to a molded part formed from a substantially identical reference composition comprising the same thermoplastic component and the same weight percentage of the same reinforcement fiber component, but in the absence of the maleic anhydride additive component.

30. The fiber reinforced thermoplastic composition of claim 1, wherein at 140° C., a molded part formed from the thermoplastic composition exhibits a greater tensile modulus compared to a molded part formed from a substantially identical reference composition comprising the same thermoplastic component and the same weight percentage of the same reinforcement fiber component, but in the absence of the maleic anhydride additive component.

31. The fiber reinforced thermoplastic composition of claim 1, wherein at 140° C., a molded part formed from the thermoplastic composition exhibits a greater tensile strength compared to a molded part formed from a substantially identical reference composition comprising the same thermoplastic component and the same weight percentage of the same reinforcement fiber component, but in the absence of the maleic anhydride additive component.

32. A fiber reinforced thermoplastic composition, comprising
a) from about 60 weight % to about 90 weight % of said fiber reinforced thermoplastic composition of a thermoplastic polymer component comprising a polycarbonate-polybutylene terephthalate (PC/PBT) blend;
b) from greater than 10 weight % to about 30 weight % of said fiber reinforced thermoplastic composition a reinforcement filler component; and
c) from 2 weight % to about 6 weight % of said fiber reinforced thermoplastic composition a maleic anhydride additive component comprising maleic anhydride grafted polypropylene.

33. The fiber reinforced thermoplastic composition of claim 32, wherein the reinforcement fiber component comprises carbon fibers having a tensile modulus in the range of from 28 to 48 MSI.

34. The fiber reinforced thermoplastic composition of claim 32, wherein the maleic anhydride component is a maleic anhydride grafted polypropylene.

35. (canceled)

36. (canceled)

37. The fiber reinforced thermoplastic composition of claim 32, wherein the thermoplastic polymer component is a polycarbonate-polybutylene terephthalate (PC/PBT) blend.

38. The fiber reinforced thermoplastic composition of claim 32, wherein at room temperature, a molded part formed from the thermoplastic composition exhibits a greater tensile modulus compared to a molded part formed from a substantially identical reference composition comprising the same thermoplastic component and the same weight percentage of the same reinforcement fiber component, but in the absence of the maleic anhydride additive component.

39. The fiber reinforced thermoplastic composition of claim 32, wherein at room temperature, a molded part formed from the thermoplastic composition exhibits a greater flexural modulus compared to a molded part formed from a substantially identical reference composition comprising the same thermoplastic component and the same weight percentage of the same reinforcement fiber component, but in the absence of the maleic anhydride additive component.

40. The fiber reinforced thermoplastic composition of claim 32, wherein at room temperature, a molded part formed from the thermoplastic composition exhibits a greater tensile strength compared to a molded part formed from a substantially identical reference composition comprising the same thermoplastic component and the same weight percentage of the same reinforcement fiber component, but in the absence of the maleic anhydride additive component.

41. The fiber reinforced thermoplastic composition of claim 32, wherein at room temperature, a molded part formed from the thermoplastic composition exhibits a greater flexural strength compared to a molded part formed from a substantially identical reference composition comprising the same thermoplastic component and the same weight percentage of the same reinforcement fiber component, but in the absence of the maleic anhydride additive component.

42. The fiber reinforced thermoplastic composition of claim 32, wherein at room temperature, a molded part formed from the thermoplastic composition exhibits a greater notched Izod impact strength compared to a molded part formed from a substantially identical reference composition comprising the same thermoplastic component and the same weight percentage of the same reinforcement fiber component, but in the absence of the maleic anhydride additive component.

43. An article of manufacture comprising the fiber reinforced thermoplastic composition according to claim 1.

44. A method for forming a thermoplastic blend comprising:
a) combining:
i) a thermoplastic polymer component comprising a combination of polycarbonate and polyalkylene terephthalate;
ii) a reinforcement fiber component; and
iii) a maleic anhydride additive component in the amount of from about 2% to about 10% of the weight of said thermoplastic blend.

45. The method of claim 44, wherein the step of combining comprises extrusion blending.

46. The method of claim 45, further comprising step of molding the thermoplastic polymer blend composition into a molded article.

47. The method of claim 44, wherein the reinforcement fiber component comprises carbon fibers.

48. (canceled)

49. (canceled)

50. The method of claim 44, wherein the thermoplastic polymer component is a polycarbonate-polybutylene terephthalate (PC/PBT) blend.

51. The method of claim 44, wherein the maleic anhydride component is a maleic anhydride grafted polypropylene.

52. The method of claim 44, wherein at room temperature, a molded part formed from the thermoplastic composition exhibits a greater tensile modulus compared to a molded part formed from a substantially identical reference composition comprising the same thermoplastic component and the same weight percentage of the same reinforcement fiber component, but in the absence of the maleic anhydride additive component.

53. The method of claim 44, wherein at room temperature, a molded part formed from the thermoplastic composition exhibits a greater flexural modulus compared to a molded part formed from a substantially identical reference composition comprising the same thermoplastic component and the same weight percentage of the same reinforcement fiber component, but in the absence of the maleic anhydride additive component.

54. The method of claim 44, wherein at room temperature, a molded part formed from the thermoplastic composition exhibits a greater tensile strength compared to a molded part formed from a substantially identical reference composition comprising the same thermoplastic component and the same weight percentage of the same reinforcement fiber component, but in the absence of the maleic anhydride additive component.

55. The method of claim 44, wherein at room temperature, a molded part formed from the thermoplastic composition exhibits a greater flexural strength compared to a molded part formed from a substantially identical reference composition comprising the same thermoplastic component and the same weight percentage of the same reinforcement fiber component, but in the absence of the maleic anhydride additive component.

56. The method of claim 44, wherein at room temperature, a molded part formed from the thermoplastic composition exhibits a greater notched Izod impact strength compared to a molded part formed from a substantially identical reference composition comprising the same thermoplastic component and the same weight percentage of the same reinforcement fiber component, but in the absence of the maleic anhydride additive component.
